(19) United States
(12) Patent Application Publication
(10) Pub. No.: US 2025/0037589 A1
(43) Pub. Date: Jan. 30, 2025

(54) AUTONOMOUS PROTECTED FLIGHT ZONES DURING EMERGENCY OPERATIONS OF AERIAL VEHICLES

(71) Applicant: HONEYWELL INTERNATIONAL INC., CHARLOTTE, NC (US)

(72) Inventors: Jayasenthilnathan Balasubramanian, Phoenix, AZ (US); Timothy Zieska, Phoenix, AZ (US); Alfredo Gonzalez, Phoenix, AZ (US)

(21) Appl. No.: 18/357,386

(22) Filed: Jul. 24, 2023

(51) Int. Cl. G08G 5/00

(52) U.S. Cl. CPC G08G 5/0056; G08G 5/0008; G08G 5/0021

(57) ABSTRACT

Embodiments of the present disclosure are directed to providing autonomous protected flight zones during emergency operations of aerial vehicles. In an example embodiment, a three-dimensional (3D) protected zone around a flight path for an aerial vehicle associated with an emergency operations event is generated based on emergency flight plan information for the aerial vehicle. Additionally, the 3D protected zone and/or the emergency flight plan information are broadcasted to a different aerial vehicle in a certain vicinity of the aerial vehicle. In response to the aerial vehicle arriving at a designated location, a removal indicator for the 3D protected zone and/or the emergency flight plan information are broadcasted to the different aerial vehicle.

### TECHNICAL FIELD

Embodiments of the present disclosure generally relate to safely managing a flight plan associated with the operation of an aerial vehicle, and more specifically to generating communications and/or control signals for an aerial vehicle that are characterized by an emergency flight path for the aerial vehicle or one or more other aerial vehicles.

### BACKGROUND

As the aerospace industry continues to deploy more aerial vehicles, it is desirable for the aerial vehicles are able to increasingly operate in an autonomous flight mode. However, there are multiple factors that can impact the efficiency, safety, and/or operation of an aerial vehicle during an autonomous flight mode. In general, various sensors, monitors, and systems associated with the electric aerial vehicle may provide raw data related to particular operational components of the aerial vehicle to provide situational awareness, contextual information, and/or other useful data for the aerial vehicle. However, the inventors have discovered various problems with current autonomous flight techniques related to aerial vehicles. Through applied effort, ingenuity, and innovation, the inventors have solved many of these problems by developing the solutions embodied in the present disclosure, the details of which are described further herein.

### BRIEF SUMMARY

In general, embodiments of the present disclosure herein provide autonomous protected flight zones during emergency operations of aerial vehicles. Other implementations will be, or will become, apparent to one with skill in the art upon examination of the following figures and detailed description. It is intended that all such additional implementations be included within this description be within the scope of the disclosure and be protected within the scope of the following claims.

In an embodiment, a computer-implemented method is provided. The computer-implemented method is performable by one or more specially configured computing device(s) embodied in hardware, software, firmware, and/or any combination thereof, for example as described herein. In one or more embodiments, the computer-implemented method includes generating a three-dimensional (3D) protected zone around a flight path for an aerial vehicle associated with an emergency operations event based on emergency flight plan data for the aerial vehicle. In one or more embodiments, the computer-implemented method additionally or alternatively includes broadcasting the 3D protected zone and the emergency flight plan data to a different aerial vehicle in a certain vicinity of the aerial vehicle. In one or more embodiments, in response to the aerial vehicle arriving at a designated location, the computer-implemented method additionally or alternatively includes broadcasting a removal indicator for the 3D protected zone and the emergency flight plan data to the different aerial vehicle.

In one or more embodiments, broadcasting the 3D protected zone and the emergency flight plan data includes broadcasting the 3D protected zone and the emergency flight plan data via wireless communication.

In one or more embodiments, broadcasting the 3D protected zone and the emergency flight plan data includes broadcasting the 3D protected zone and the emergency flight plan data via satellite communication.

In one or more embodiments, the emergency flight plan data includes an emergency flight path of the aerial vehicle and an emergency destination location of the aerial vehicle.

In one or more embodiments, the computer-implemented method additionally or alternatively includes causing rendering of a graphical element associated with the 3D protected zone via a display of the different aerial vehicle. In one or more embodiments, the display is a primary flight display of the different aerial vehicle. In one or more embodiments, the display is a vertical situation display of the different aerial vehicle.

In one or more embodiments, the computer-implemented method additionally or alternatively includes causing rendering of a graphical element associated with the 3D protected zone via a primary flight display and a vertical situation display of the different aerial vehicle.

In one or more embodiments, the computer-implemented method additionally or alternatively includes causing rendering of a graphical element associated with the 3D protected zone via a display of a remote operations platform.

In one or more embodiments, the computer-implemented method additionally or alternatively includes receiving, from the different aerial vehicle, an acceptance indicator for the 3D protected zone in response to a user action with respect to an interactive graphical element rendered via a display of the different aerial vehicle.

In another embodiment, an apparatus is provided. In one or more embodiments, the apparatus includes at least one processor and at least one memory having computer-coded instructions stored thereon, where the computer-coded instructions in execution with the at least one processor causes the apparatus to perform any one of the example computer-implemented methods described herein. In one or more embodiments, the apparatus includes means for performing each step of any one of the example computer-implemented methods described herein.

In yet another embodiment, a computer program product is provided. In one or more embodiments, the computer program product includes at least one non-transitory computer-readable storage medium having computer program code stored thereon that, in execution with at least one processor, configures the computer program product for performing any one of the example computer-implemented methods described herein.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system that provides autonomous protected flight zones during emergency operations of aerial vehicles in accordance with one or more embodiments of the present disclosure;

FIG. 2 illustrates an example vehicle apparatus in accordance with one or more embodiments of the present disclosure;

FIG. 3 illustrates an example flight management platform in accordance with one or more embodiments of the present disclosure;

FIG. 4 illustrates an operational example of an electronic display configured to display one or more overlays in accordance with one or more embodiments of the present disclosure;

FIG. 5 illustrates an operational example of another electronic display configured to display one or more overlays in accordance with one or more embodiments of the present disclosure;

FIG. 6 illustrates an operational example of yet another electronic display configured to display one or more overlays in accordance with one or more embodiments of the present disclosure;

FIG. 7 illustrates an operational example of yet another electronic display configured to display one or more overlays in accordance with one or more embodiments of the present disclosure; and

FIG. 8 illustrates a flowchart depicting example operations of an example process for providing autonomous protected flight zones during emergency operations of aerial vehicles in accordance with one or more embodiments of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### OVERVIEW

As the various branches of the transportation industry move ever towards semi-autonomously and autonomously controlled aerial vehicles, operators, pilots, drivers, and/or control systems associated with respective aerial vehicles may have further limited knowledge and/or limited experience with which to make crucial decisions regarding one or more adverse situations impacting the operation of the aerial vehicle. In this regard, the cognitive workload for the operator to gain a complete situational awareness based at least in part on disparate data coming from a multitude of sources remains high or even may increase, and, in some circumstances, it is difficult or impossible for an operator to make an accurate decision and perform a corresponding action based at least in part on the many nuances of a given, often time-sensitive, situation.

Furthermore, in scenarios in which the semi-autonomously and autonomously controlled aerial vehicles are exposed to emergency situations, it becomes critical that the operators, pilots, drivers, and/or control systems associated with respective aerial vehicles understand risks and/or optimal flight paths for the execution of a particular emergency flight plan. For example, consider a scenario where a semi-autonomously or autonomously controlled aerial vehicle encounters a contingency or emergency scenario in which the aerial vehicle is unable to meet an operational intent due to a failure. In such a scenario, the aerial vehicle may be forced to land, and may result in undesirable inefficiencies and/or damage to the aerial vehicle. Moreover, manual communications, instructions, and/or actions to alter a flight path of the aerial vehicle during a contingency or emergency scenario can result in added delays and/or errors to execute the new flight path for the aerial vehicle, resulting in additional inefficiencies for a control system and/or overall system for the aerial vehicle.

Embodiments of the present disclosure are configured to address the limitations of traditional vehicle management systems by providing autonomous protected flight zones during emergency operations of aerial vehicles. In various embodiments, autonomous avoidance of intrusion via autonomous protected flight zones is provided during emergency operations through aircraft-to-aircraft connectivity and/or related communications between aircrafts. As such, autonomous, dynamic, cooperative, and/or safe traffic management for aerial vehicles can be provided. Additionally, efficiency of aerial vehicles and/or related systems can be improved while also mitigating damage to the aerial vehicles.

In various embodiments, a flight management system (FMS) and/or another system of an aerial vehicle can repeatedly compute (e.g., continuously compute) emergency flight plans based on a real-time position, attitude, and/or other real-time data of the aerial vehicle. Additionally or alternatively, the aerial vehicle can receive an emergency flight plan from an operation center (e.g., a remote operations platform) where a remote pilot can remotely control the aerial vehicle. Upon detection of an emergency operation (e.g., an emergency operation event), the FMS and/or another system of the aerial vehicle can utilize an emergency flight plan and/or can autonomously execute the emergency flight plan to land the aerial vehicle at an emergency destination location as indicated by the emergency flight plan. Alternatively, an onboard Pilot in Command (PIC) or a remote PIC can execute the emergency flight plan and land the aircraft accordingly at the emergency destination location.

In various embodiments, upon detection of the emergency operation, a three-dimensional (3D) protected zone may be constructed around a flight path for an emergency flight plan. For example, the 3D protected zone may indicate a 3D visualization of temporary flight restrictions (e.g., an area with restricted air travel) for one or more aerial vehicles within a vicinity from the aerial vehicle associated with the emergency operation. In various embodiments, the 3D protected zone is broadcasted (e.g., by the aerial vehicle associated with the emergency operation) to the one or more aerial vehicles within the vicinity from the aerial vehicle associated with the emergency operation. The 3D protected zone can be broadcasted via satellite, cellular, low earth orbit (LEO) satellite connectivity, or another type of communication. In certain embodiments, the 3D protected zone can be broadcasted in response to communication connectivity being established between the aerial vehicle and a different aerial vehicle. Additionally or alternatively, one or more other types of information associated with an emergency flight plan can be broadcasted in response to communication connectivity being established between the aerial vehicle and a different aerial vehicle. In addition to broadcasting the 3D protected zone and/or other emergency flight plan data to one or more aerial vehicles within the vicinity from the aerial vehicle, the 3D protected zone and/or other emergency flight plan data can be broadcasted to another type of remote system such as an air traffic control (ATC) system, an unmanned aircraft system traffic management (UTM) system, and/or another type of system remotely located with respect to the aerial vehicle.

In various embodiments, the 3D protected zone, an emergency flight path, and/or other emergency flight plan data can be displayed via a display of the aerial vehicle, one or more other aerial vehicles with established connectivity with respect to the aerial vehicle. and/or a remote system with respect to the aerial vehicle. For example, a display of an aerial vehicle can include, but is not limited to, a cockpit display, a navigation map display, a primary flight display (PFD), a head up display (HUD), a vertical situation display (VSD), a Near-to-Eye display, an augmented reality (AR) display, a virtual reality (VR) display, and/or another type of display onboard an aerial vehicle or integrated as a part of a remote platform. In various embodiments, in response to receiving the 3D protected zone and/or other emergency flight plan data, the one or more other aerial vehicles with established connectivity with respect to the aerial vehicle can dynamically alter a respective flight plan for the one or more other aerial vehicles such that the one or more other aerial vehicles avoid violation of temporary flight restrictions within the 3D protected zone. Alternation of the respective flight plan for the one or more other aerial vehicles can be manually accepted or rejected by a pilot of the one or more aircrafts, or alternation of the respective flight plan for the one or more other aerial vehicles can be autonomously analyzed and accepted by a control system of the one or more other aerial vehicles.

In certain embodiments, if a system of the one or more other aerial vehicles does not receive pilot input on the alternate flight plan for a specific time, the alternate flight plan can be autonomously executed to avert an intrusion within the 3D protected zone. Thus without an ATC intervention, it can be ensured that others aerial vehicles in the airspace surrounding the aerial vehicle does not intrude on the emergency flight path region of the aerial vehicle under the emergency condition, and respective aerial vehicles can autonomously manage the emergency scenario.

By utilizing autonomous protected flight zones during emergency operations of aerial vehicles as disclosed herein, one or more adverse situations for aerial vehicles can be mitigated. Additionally, by utilizing autonomous protected flight zones during emergency operations of aerial vehicles as disclosed herein, a number of computational resources needed by an aerial vehicle may be advantageously reduced. Power consumption by an aerial vehicle can therefore also be reduced. Moreover, processing efficiency for a control system of an aerial vehicle may be improved and/or damage to an aerial vehicle may be mitigated by utilizing autonomous protected flight zones during emergency operations of aerial vehicles as disclosed herein.

It will be appreciated that embodiments of the present disclosure may be advantageous for a myriad of vehicle types. In this regard, aerial vehicles are utilized as an exemplary type of vehicle for purposes of simplifying the disclosure. The description specific to aerial vehicles should not limit the scope and spirit of the disclosure unless otherwise explicitly stated. For example, the systems, techniques, and/or methods described herein may be applicable to the fields of autonomous aircraft operation, autonomous automobile operation, autonomous watercraft operation, autonomous spacecraft operation, and/or the like.

### DEFINITIONS

In one or more embodiments, the term “flight management platform” refers to a vehicle platform or module configured to provide autonomous protected flight zones during emergency operations of aerial vehicles. A flight management platform can identify and/or mitigate one or more adverse situations related to an emergency operation that can impact the operation of the one or more vehicles. For example, one or more components of the flight management platform can be configured to determine and/or execute one or more flight plans associated with the one or more vehicles by employing emergency flight plan data for the one or more vehicles. Additionally or alternatively, one or more components of the flight management platform can be configured to determine and/or execute a 3D protected zone around a flight path for a vehicle. A flight management platform in some embodiments is associated with one or more systems such as, for example, a logistics system, a delivery and shipment system, a commercial airline system, an aerial delivery system, an urban air mobility (UAM) system, an advanced air mobility (AAM) system, and/or the like that manages and/or deploys a fleet of vehicles. The flight management in some embodiments includes and/or integrates with one or more system(s), computing device(s), service(s), machine learning model(s), and/or datastore(s). For example, the flight management can interface with one or more vehicle operation management system(s), environment data system(s), air traffic control system(s), UAM systems, and/or the like.

In one or more embodiments, the term “onboard flight management system” refers to hardware, software, firmware, and/or a combination thereof, that embodies and/or maintains an application instance configured to integrate with one or more vehicle systems and/or apparatuses associated with a vehicle to provide autonomous protected flight zones during emergency operations of aerial vehicles. The onboard flight management system comprises, and/or integrates with, among other components, an emergency flight plant system, a vehicle monitoring system, and/or one or more electronic displays. The onboard flight management system can be configured to transmit and/or receive data related to the operation and/or emergency conditions related to one or more vehicles via a communications network. In this regard, the onboard flight management system in some embodiments generates, transmits and/or receives data including, but not limited to, emergency flight plan data, 3D protected zone data, vehicle operation management data, vehicle data, environmental data, logistics data, hazard data, air traffic data, road traffic data, and/or the like. In certain embodiments, the onboard flight management system can generate an emergency flight plan overlay. In various embodiments, the emergency flight plan overlay corresponds to a 3D protected zone around a flight plan of a vehicle. The emergency flight plan overlay can be configured to display over a respective electronic display associated with one or more computing devices depicting an environment of the vehicle.

As a non-limiting example, the emergency flight plan overlay can be configured in a first-person perspective, an overhead perspective, or a vertical situational display perspective characterized by an emergency flight plan and a 3D protected zone such that a flight plan in combination with a 3D protected zone can be visualized relative to a current heading, altitude, and/or velocity of the vehicle. As such, the emergency flight plan overlay can be displayed via an electronic display associated with one or more respective computing devices (e.g., a primary flight display of an aerial vehicle).

In one or more embodiments, the term “adverse situation” refers to a data-driven determination or characteristic of an effect or operational state of a vehicle or subsystem thereof. For instance, an adverse situation in some embodiments is an emergency condition impacting the operation of the vehicle and/or one or more persons associated with the vehicle. An adverse situation in some embodiments can also be a circumstance affecting the optimization of one or more vehicle systems associated with the vehicle (e.g., a battery system, a control system, or the like). A few non-limiting examples of adverse situation types that in some embodiments is associated with a respective adverse situation include, an emergency situation type, a hazard situation type, a mechanical failure situation type, a logistical situation type, an environmental situation type, an optimization situation type, a vehicle damage situation type, and/or the like. Determination of an adverse situation in some embodiments is based in part on one or more portions of vehicle performance data. In some embodiments, an onboard flight management system can be configured to identify, classify, categorize, and/or analyze one or more adverse situations impacting the operation of a vehicle to facilitate generation of a 3D protected zone and/or other emergency flight plan data.

In one or more embodiments, the term “vehicle operation data” refers to data indicative of an operational state of a vehicle or a particular subsystem thereof. Vehicle operation data can comprise data collected, measured, obtained, generated, and/or otherwise processed by the one or more vehicle system(s) associated with the vehicle. In various embodiments, one or more portions of vehicle operation data, in some embodiments, is received from the vehicle operations center via a communications network. In various embodiments, at least a portion of the vehicle operation data is based at least in part on vehicle sensor data collected, measured, calculated, and/or otherwise generated by one or more sensors associated with the vehicle. Additionally or alternatively, in various embodiments, vehicle operation data can include at least one data value indicating whether a vehicle is operating in a nominal scenario, data indicative of an emergency scenario, data indicative of a hazard scenario, data indicative of a logistical scenario that alters the voyage of the vehicle, and/or data indicative of a change in the operation of a system affecting control of the vehicle.

In one or more embodiments, the term “vehicle sensor data” refers to electronically managed data utilized by a vehicle for operation that is captured by at least one sensor onboard or otherwise communicable with the vehicle. Vehicle sensor data in some embodiments is any data collected, measured, calculated, and/or otherwise generated by one or more sensors associated with the vehicle.

In one or more embodiments, the term “performance monitor” refers to an ML model that is specially configured to receive one or more portions of vehicle operation data and, based at least in part on the one or more portions of vehicle operation data, generate one or more portions of vehicle performance data describing one or more operational states of the vehicle. Additionally, the performance monitor can be associated with an onboard flight management system and/or can be configured to identify, classify, categorize, and/or analyze one or more adverse situations impacting the operation of a vehicle.

In one or more embodiments, the term “flight plan” refers to one or more portions of data related to at least one or more destinations, waypoints, flight paths, arrival/departure schedules and/or procedures, routes, missions, traffic management constraints, trip parameters, and/or the like that have been predetermined for a particular vehicle (e.g., a particular aerial vehicle). In certain embodiments, a flight path can be an emergency flight path for a vehicle.

In one or more embodiments, the term “3D protected zone” refers to a dynamic zone (e.g., an autonomous protected flight zone) constructed around a flight path in 3D. For example, the 3D protected zone can indicate a 3D area surrounding a flight path for a vehicle. In various embodiments, the 3D protected zone can indicate a 3D visualization of temporary flight restrictions (e.g., an area with restricted air travel) for one or more aerial vehicles within a vicinity from an aerial vehicle associated with an emergency operation. In various embodiments, the 3D protected zone is constructed from x-coordinates, y-coordinates, and z-coordinates. In various embodiments, the 3D protected zone includes altitude, latitude and/or longitude dimensionality.

In one or more embodiments, the term “emergency flight plan data” refers to data indicative of an emergency scenario that affects the voyage of a aerial vehicle and/or data indicative of a change in an operation of a system affecting control of the aerial vehicle. In various embodiments, at least a portion of the emergency flight plan data is based at least in part on vehicle sensor data collected, measured, calculated, and/or otherwise generated by one or more sensors associated with the aerial vehicle. The vehicle sensor data can be electronically managed data utilized by an aerial vehicle for operation. For example, the vehicle sensor data can be any data collected, measured, calculated, and/or otherwise generated by one or more sensors associated with the aerial vehicle.

In one or more embodiments, the term “emergency operations event” refers to a situation and/or circumstance that has the potential to impact the operation of an aerial vehicle. For instance, an emergency operations event can be an emergency situation impacting the operation of the aerial vehicle and/or one or more persons associated with the aerial vehicle. An emergency operations event can also be a circumstance affecting the optimization of one or more vehicle systems associated with the aerial vehicle. A few non-limiting examples of event types that can be associated with a respective emergency operations event include, an emergency event type, a hazard event type, a mechanical failure event type, a logistical event type, an environmental event type, an optimization event type, a personnel health event type, and/or the like. Determination of an emergency operations event can be based in part on one or more portions of travel event data and/or one or more portions of vehicle sensor data.

In one or more embodiments, the term “removal indicator” refers to electronically managed data or data object representing a value, variable, attribute, or particular criteria or property having a particular value or status regarding removal of a 3D protected zone for one or more flight paths. In some embodiments, the removal indicator is dynamically assigned for one or more aerial vehicles based on another aerial vehicle arriving at a designated location. In certain embodiments, the removal indicator can be configured as a control signal to indicate or initiate removal of a visual rendering of a 3D protected zone via a display.

In one or more embodiments, the term “designated location” refers to a destination, a transportation hub, a logistics hub, and/or another type of geographical location that is configured to serve one or more inbound and/or outbound vehicles. Non-limiting examples of a designated location include an airport, a vertiport, a helipad, a hangar, a vehicle fueling station, a vehicle pool, a service station, a vehicle maintenance facility, a vehicle manufacturing facility, a vehicle sales facility, and/or the like.

In one or more embodiments, the term “aerial vehicle” refers to any manned or unmanned vehicle capable of air travel. Non-limiting examples of an aerial vehicle include an aircraft, an airplane, a helicopter, an unmanned aerial vehicle, an electric aerial vehicle, an electronic vertical takeoff or landing (eVTOL) aircraft, a jet, a drone, or a quadcopter. At least some aerial vehicles are controllable by system(s) onboard the aerial vehicle. At least some aerial vehicles are controllable by system(s) external from the aerial vehicle including. and without limitation, remote control system(s), ground system(s), and centralized control system(s). In various embodiments, an aerial vehicle can be an electric aerial vehicle that is powered partially or completely by a battery system integrated with the electric aerial vehicle.

In one or more embodiments, the term “computing device” refers to any computer, processor, circuitry, and/or other executor of computer instructions that is embodied in hardware, software, firmware, and/or any combination thereof. Non-limiting examples of a computing device include a computer, a processor, an application-specific integrated circuit, a field-programmable gate array, a personal computer, a smart phone, a laptop, a fixed terminal, a server, a networking device, and a virtual machine.

In one or more embodiments, the term “user computing device” refers to a computing device associated with a person, company, or other organizational structure that controls one or more systems. In some embodiments, a user computing device is associated with particular administrative credentials that define access to operation via a particular system.

In one or more embodiments, the term “executable code” refers to a portion of computer program code stored in one or a plurality of locations that is executed and/or executable via one or more computing devices embodied in hardware, software, firmware, and/or any combination thereof. Executable code defines at least one particular operation to be executed by one or more computing devices. In some embodiments, a memory, storage, and/or other computing device includes and/or otherwise is structured to define any amount of executable code (e.g., a portion of executable code associated with a first operation and a portion of executable code associated with a second operation). Alternatively or additionally, in some embodiments, executable code is embodied by separate computing devices (e.g., a first datastore embodying first portion of executable code and a second datastore embodying a second portion executable code).

In one or more embodiments, the term “datastore,” “database,” and “data lake” refer to any type of non-transitory computer-readable storage medium. Non-limiting examples of a datastore, database, and/or data lake include hardware, software, firmware, and/or a combination thereof capable of storing, recording, updating, retrieving and/or deleting computer-readable data and information. In various embodiments, a datastore, database, and/or data lake in some embodiments is a cloud-based storage system accessible via a communications network by one or more components of the various embodiments of the present disclosure.

In one or more embodiments, the term “data value” refers to electronically managed data representing a particular value for a particular data attribute, operational parameter, sensor device, and/or the like.

The phrases “in an embodiment,” “in one embodiment,” “according to one embodiment,” and the like generally mean that the particular feature, structure, or characteristic following the phrase in some embodiments is included in at least one embodiment of the present disclosure, and in some embodiments is included in more than one embodiment of the present disclosure (importantly, such phrases do not necessarily refer to the same embodiment). The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature in some embodiments is optionally included in some embodiments, or it in some embodiments is excluded.

As used herein, the terms “data,” “content,” “digital content,” “data object,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

### EXAMPLE SYSTEMS, APPARATUSES, AND DATAFLOWS OF THE DISCLOSURE

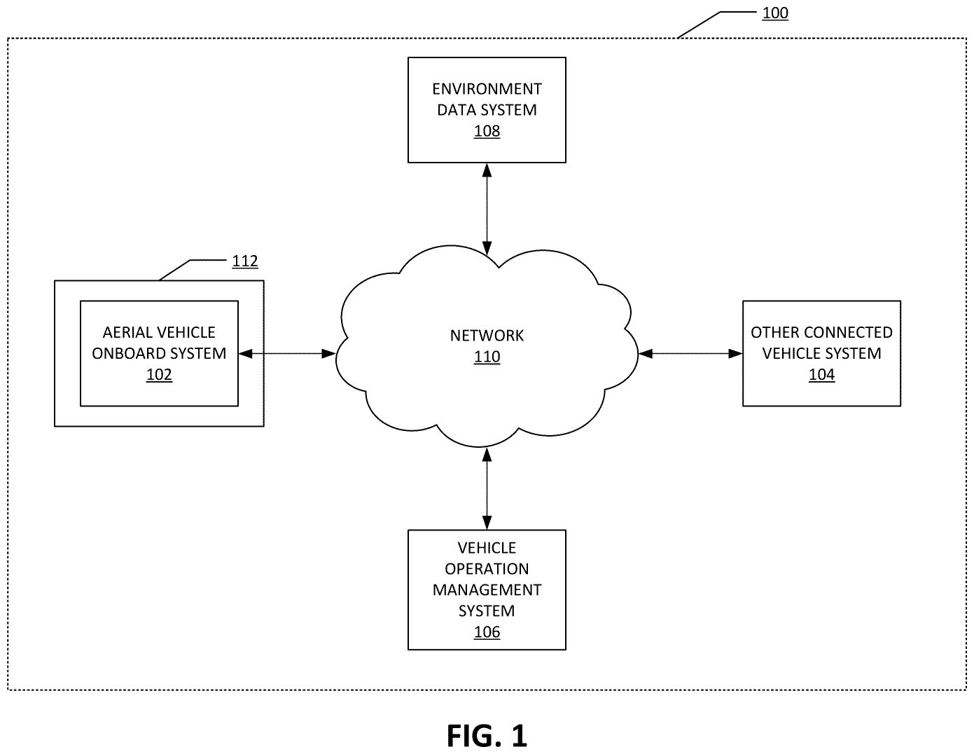

FIG. 1 illustrates an example system that provides autonomous protected flight zones during emergency operations of aerial vehicles in accordance with at least some example embodiments of the present disclosure. Specifically, FIG. 1 depicts an example system 100 within which embodiments of the present disclosure may operate to manage autonomous protected flight zones during an emergency operation of an aerial vehicle 112. As depicted, the system 100 includes aerial vehicle onboard system(s) 102 associated with the aerial vehicle 112. Additionally or alternatively, in some embodiments, the aerial vehicle 112 is communicable (e.g., via the aerial vehicle onboard system(s) 102) with one or more external computing device(s) and/or system(s). For example, in some embodiments, the aerial vehicle onboard system(s) 102 is optionally communicable with some or all of the other connected vehicle system(s) 104, vehicle operation management system(s) 106, and/or environment data system(s) 108. In some such embodiments, the aerial vehicle onboard system(s) 102 communicates with the other connected vehicle system(s) 104, vehicle operation management system(s) 106, and/or environment data system(s) 108 via one or more specially configured communications network(s), for example the network 110.

In some embodiments, the aerial vehicle onboard system(s) 102 includes any number of computing device(s) and/or system(s) embodied in hardware, software, firmware, and/or a combination thereof, that control, operate, and/or otherwise function onboard an aerial vehicle 112. For example, in some embodiments, the aerial vehicle onboard system(s) 102 includes one or more physical component(s) of the aerial vehicle 112, including and without limitation one or more display(s), flight management system(s), vehicle operation management system(s), engine(s), wing(s), prop(s), motor(s), antenna(s), landing gear(s), and/or the like. In some embodiments, the aerial vehicle onboard system(s) 102 includes one or more sensor(s) that gather, collect, and/or otherwise aggregates sensor data relevant to operation of the aerial vehicle 112, associated with the aerial vehicle 112, and/or otherwise associated with an environment of the aerial vehicle 112.

Additionally or alternatively, in some embodiments, the aerial vehicle onboard system(s) 102 includes one or more computing device(s) and/or system(s) embodied in hardware, software, firmware, and/or a combination thereof, that control(s) operation of one or more physical components of the aerial vehicle 112. For example and without limitation, in some embodiments the aerial vehicle onboard system(s) 102 includes computing device(s) and/or system(s) that control one or more display(s), flight management system(s), vehicle operation management system(s), engine(s), wing(s), prop(s), motor(s), antenna(s), landing gear(s), sensor(s), and/or the like.

Additionally or alternatively, in some embodiments, the aerial vehicle onboard system(s) 102 includes one or more computing device(s) and/or system(s) embodied in hardware, software, firmware, and/or a combination thereof, that generates and/or otherwise causes rendering of one or more user interface(s) renderable to one or more display(s) onboard and/or otherwise associated with the aerial vehicle 112. In some embodiments such computing device(s) and/or system(s) specially configure some or all element(s) of user interface(s) to be rendered based at least in part on received data. It should be appreciated that the aerial vehicle onboard system(s) 102 in some embodiments includes any of a myriad of specially configured computing device(s) and/or system(s) that enable the aerial vehicle 112 to operate in a particular manner of airborne travel. For example, in various embodiments, the aerial vehicle onboard system(s) 102 may include a primary flight display (PFD), an electronic flight bag (EFB), a flight management system (FMS), a gateway computing device, and/or the like. In various embodiments, the aerial vehicle onboard system(s) 102 associated with a respective vehicle may be configured in a line replaceable unit (LRU).

In some embodiments, the aerial vehicle onboard system(s) 102 includes one or more personal computer(s), end-user terminal(s), monitor(s), or other display(s), and/or the like. Additionally or alternatively, in some embodiments, the aerial vehicle onboard system(s) 102 includes one or more data repository/data repositories embodied in hardware, software, firmware, and/or any combination thereof, to support functionality provided by the aerial vehicle onboard system(s) 102. For example, in some embodiments, such data repositories provide data storage functionality on the same computing device(s) and/or other dedicated computing device(s) of the aerial vehicle onboard system(s) 102. Additionally or alternatively still, in some embodiments, the aerial vehicle onboard system(s) 102 includes one or more specially configured integrated system(s), circuit(s), and/or the like that process data received by and/or control one or more other computing device(s) and/or system(s), or physical component(s), associated with the aerial vehicle 112.

The aerial vehicle 112 may embody any of a myriad of aerial vehicle types. The aerial vehicle 112 includes any number of physical component(s) that enable air travel, including and without limitation prop(s), rotor(s), engine(s), wing(s), and/or the like. Additionally or alternatively, the aerial vehicle 112 includes any number of a myriad of controls for operating the physical components of the aerial vehicle 112 to achieve such airborne travel. For example, in some embodiments, the aerial vehicle 112 includes a forward-flying aerial vehicle. In some embodiments, the aerial vehicle 112 includes a vertical takeoff and landing aerial vehicle. It will be appreciated that the aerial vehicle 112 may be entirely manually controlled, semi-autonomous, fully autonomous for one or more operations, or any combination thereof. Non-limiting examples of an aerial vehicle 112 include a plane generally, a helicopter, a drone, an eVTOL, a prop-based aircraft, a jet, and/or the like. Any particular vehicle type utilized in this disclosure is purely illustrative, and not to limit the scope and/or spirit of this disclosure or the appended claims presented herewith.

The other connected vehicle system(s) 104 includes computing device(s), system(s), and/or onboard system(s) of other vehicle(s) communicatively coupled with the aerial vehicle 112 associated with aerial vehicle onboard system(s) 102. It will be appreciated that the other connected vehicle system(s) 104 in some embodiments includes computing device(s) and/or system(s) of one or more other aerial vehicle(s) of the same type operating within the same environment as the aerial vehicle associated with aerial vehicle onboard system(s) 102. For example, in some embodiments some of the other connected vehicle system(s) 104 include computing device(s) and/or system(s) of other aerial vehicle(s) in a fleet of a particular type of aerial vehicle. In some such embodiments, sensor data (for example) captured via such other connected vehicle system(s) 104 similarly may be applicable to the aerial vehicle 112 as well. Additionally or alternatively, in some embodiments, the other connected vehicle system(s) 104 includes computing device(s) and/or system(s) of ground vehicle(s), other types of aerial vehicle(s), and/or the like, or any combination thereof.

In some embodiments, the aerial vehicle onboard system(s) 102 receives data from one or more of the other connected vehicle system(s) 104 that provides additional context with respect to the environment in which the aerial vehicle 112 associated with aerial vehicle onboard system(s) 102 is operating. In some embodiments, such data includes sensor data that the aerial vehicle onboard system(s) 102 is able to capture, or in some embodiments includes sensor data not capturable by the aerial vehicle onboard system(s) 102. For example, in some embodiments, the aerial vehicle onboard system(s) 102 communicates with the other connected vehicle system(s) 104 to determine a position of other aerial vehicle(s), object(s), environmental feature(s) (e.g., buildings, terrain, and/or the like) within the environment of the aerial vehicle associated with aerial vehicle onboard system(s) 102, and/or the like. Additionally or alternatively, in some embodiments, the aerial vehicle onboard system(s) 102 communicate with one or more of the other connected vehicle system(s) 104 to receive sensor data of a particular data type that is not capturable directly by the aerial vehicle onboard system(s) 102. For example, in some embodiments, the aerial vehicle associated with the aerial vehicle onboard system(s) 102 does not include a particular sensor for capturing a particular type of sensor data, and instead receives such data of the particular data type from the other connected vehicle system(s) 104.

In some embodiments, the vehicle operation management system(s) 106 includes one or more computing device(s) embodied in hardware, software, firmware, and/or the like that generate, assign, and/or maintain vehicle operation constraints (e.g., flight plan data, mission goals, etc.) for one or more aerial vehicle(s). For example, in some embodiments, the vehicle operation management system(s) 106 include computing device(s) and/or system(s) of an air traffic control system and/or other authoritative entity that assigns flight plan information to one or more aerial vehicle(s). Such information includes, without limitation, flight plan information embodying a visual sight rules (VFR) flight plan, an instrument flight rules (IFR) flight plan, a composite flight plan, and/or the like defining conditions for operating an aerial vehicle 112 within a particular environment. In some embodiments, the vehicle operation management system(s) 106 captures and/or otherwise obtains particular data for relaying to the aerial vehicle 112. In some embodiments, the vehicle operation management system(s) 106 include computing device(s) and/or system(s) of a operation center (e.g., a remote operations platform) where a remote pilot can remotely control the aerial vehicle 112 and/or one or more other aerial vehicles.

In some embodiments, the vehicle operation management system(s) 106 includes one or more application server(s), end user terminal(s), personal computer(s), mobile device(s), user device(s), and/or the like that generate, assign, and/or transmit flight plan information to aerial vehicle(s). Additionally or alternatively, in some embodiments, the vehicle operation management system(s) 106 includes one or more data repository/repositories embodied in hardware, software, firmware, and/or a combination thereof, that stores flight plan information, links between flight plan information and particular aerial vehicle(s), and/or the like. In some such embodiments, the flight plan information includes navigational data, environmental data, weather data, and/or obstacle data for one or more environment(s) within which an aerial vehicle is or will be operating. Additionally or alternatively, in some embodiments, the vehicle operation management system(s) 106 includes one or more computing device(s) and/or system(s) that detect and/or monitor operation of one or more aerial vehicle(s) within an environment. For example, in some embodiments, the travel operation management system(s) 106 includes one or more radar system(s) that monitor one or more environment(s). In various embodiments, one or more portions of data associated with the vehicle operation management system(s) 106 may be stored in a navigation database.

The environment data system(s) 108 includes one or more computing device(s) and/or system(s) that monitor, capture, and/or otherwise store data representing one or more aspect(s) of a real-world environment, object(s) therein, and/or aerial vehicle(s) therein. In some embodiments, the environment data system(s) 108 includes one or more data repository/repositories that store weather and/or obstacle data for one or more environment(s). Additionally or alternatively, in some embodiments, the environment data system(s) 108 includes one or more data repository/repositories that store data embodying other environmental aspect(s) that interact with or otherwise affect operation of aerial vehicle(s) in an environment, for example the aerial vehicle 112. In some embodiments, the environment data system(s) 108 includes a satellite system that monitors one or more aspect(s) of an environment, for example a satellite weather provider and/or satellite radio provider to the aerial vehicle 112. Alternatively or additionally still, in some embodiments, the environment data system(s) 108 embody or include a flight services data provider system (e.g., a Honeywell flight services system). In some embodiments, the environment data system(s) 108 embodies a subsystem of the vehicle operation management system(s) 106 and/or other connected vehicle system(s) 104.

In some embodiments, the environment data system(s) 108 includes one or more application server(s), end user terminal(s), personal computer(s), mobile device(s), user device(s), and/or the like. Additionally or alternatively, in some embodiments, the environment data system(s) 108 includes one or more database server(s) specially configured to store data pushed from one or more other computing device(s) and/or system(s). In some embodiments, the environment data system(s) 108 includes one or more remote and/or cloud computing device(s) accessible to the aerial vehicle onboard system(s) 102, other connected vehicle system(s) 104, and/or vehicle operation management system(s) 106 over a communications network, such as the network 110. In various embodiments, one or more portions of data associated with the environment data system(s) 108 may be stored in a navigation database.

In some embodiments the network 110 enables communication between various computing device(s) and/or system(s) utilizing one or more combination(s) of wireless and/or wired data transmission protocol(s). In this regard, the network 110 in some embodiments embodies any of a myriad of network configurations. In some embodiments, the network 110 embodies a public network (e.g., the Internet) in whole or in part. In some embodiments, the network 110 embodies a private network (e.g., an internal network between particular computing devices) in whole or in part. Alternatively or additionally, in some embodiments the network 110 embodies a direct or private connection facilitated over satellite or radio system(s) that enables long-range communication between aerial vehicle(s) and corresponding grounded system(s). In some other embodiments, the network 110 embodies a hybrid network (e.g., a network enabling internal communications between particular connected computing devices and external communications with other computing devices).

The network 110 in some embodiments includes one or more base station(s), relay(s), router(s), switch(es), cell tower(s), communications cable(s), satellite(s), radio antenna(s) and/or related control system(s), and/or associated routing station(s), and/or the like. In some embodiments, the network 110 includes one or more user entity-controlled computing device(s) and/or other enterprise device(s) (e.g., an end-user's or enterprise router, modem, switch, and/or other network access point) and/or one or more external utility devices (e.g., Internet service provider communication tower(s), cell tower(s), and/or other device(s)). In some embodiments, the aerial vehicle onboard system(s) 102 communicates with one or more of the other connected vehicle system(s) 104, vehicle operation management system(s) 106, environment data system(s) 108 over the network 110 to receive and/or transmit the data described herein for generating the user interface(s) for providing to one or more display(s) of an aerial vehicle. In some embodiments, the network 110 embodies a Datalink uplink to the aerial vehicle 112 (e.g., via the aerial vehicle onboard system(s) 102) that communicatively couple the airborne system(s) to the ground system(s).

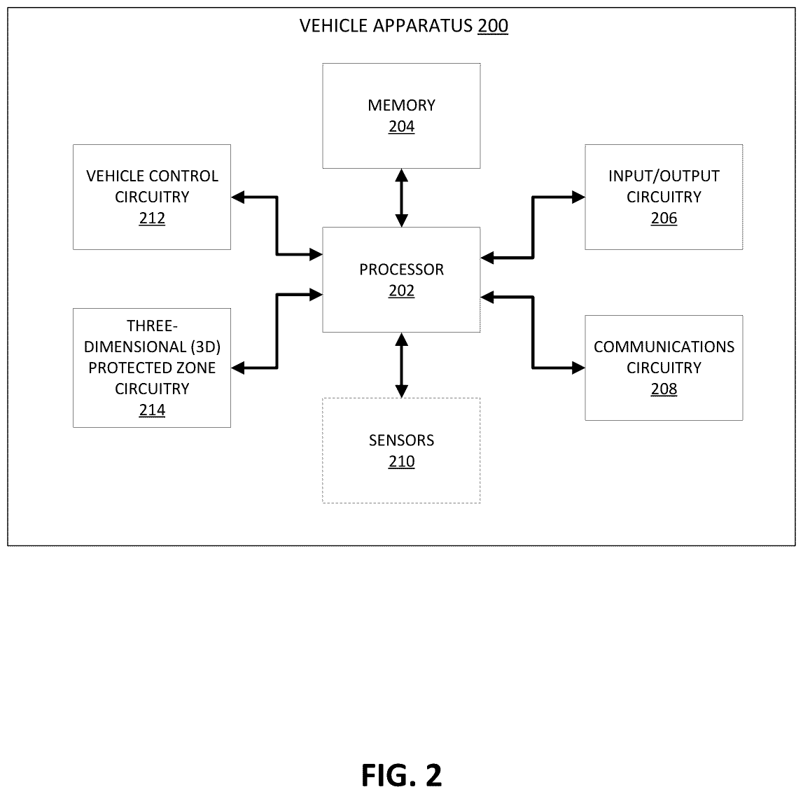

FIG. 2 illustrates an example vehicle apparatus in accordance with at least some example embodiments of the present disclosure. Specifically, FIG. 2 depicts a vehicle apparatus 200. In some embodiments, one or more computing device(s) and/or system(s) of a vehicle (e.g., an aerial vehicle 112), for example included in or embodied by the aerial vehicle onboard system(s) 102 onboard an aerial vehicle 112, is embodied by one or more computing devices such as the vehicle apparatus 200 as depicted and described in FIG. 2. In some embodiments, one or more computing device(s) and/or system(s) included in or embodied by the other connected vehicle system(s) 104 onboard one or more other aerial vehicles is embodied by one or more computing devices such as the vehicle apparatus 200 as depicted and described in FIG. 2.

As depicted, the vehicle apparatus 200 includes a processor 202, memory 204, input/output circuitry 206, communications circuitry 208, sensor(s) 210, vehicle control circuitry 212, and/or 3D protected zone circuitry 214. In some embodiments, the vehicle apparatus 200 is configured, using one or more of the sets of circuitry embodying processor 202, memory 204, input/output circuitry 206, communications circuitry 208, sensor(s) 210, vehicle control circuitry 212, and/or 3D protected zone circuitry 214, to execute one or more operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the vehicle apparatus 200 provide or supplement the functionality of another particular set of circuitry. For example, the processor 202 in some embodiments provides processing functionality to any of the other sets of circuitry, the memory 204 provides storage functionality to any of other the sets of circuitry, the communications circuitry 208 provides network interface functionality to any of the other sets of circuitry, and/or the like.

In some embodiments, the processor 202 (and/or co-processor or any other processing circuitry assisting or otherwise associated with the processor) is/are in communication with the memory 204 via a bus for passing information among components of the vehicle apparatus 200. In some embodiments, for example, the memory 204 is non-transitory and includes for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the vehicle apparatus 200 to carry out various functions in accordance with example embodiments of the present disclosure. Furthermore, in various embodiments, the memory 204 is configured to store one or more portions of data related to an emergency flight plan database, a performance database, a navigation database, and/or another type of database associated with a vehicle embodying a respective vehicle apparatus 200.

In various embodiments, the processor 202 is embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the vehicle apparatus 200, and/or one or more remote or “cloud” processor(s) external to the vehicle apparatus 200.

In an example embodiment, the processor 202 is configured to execute instructions stored in the memory 204 or otherwise accessible to the processor 202. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed.

As one particular example embodiment, the processor 202 is configured to perform various operations associated with identifying an emergency operations event, generating a 3D protected zone, broadcasting a 3D protected zone, displaying a 3D protected zone, and/or broadcasting a removal indicator, for example as described with respect to operating and/or reconfiguring the aerial vehicle onboard system(s) 102 in FIG. 1 and/or as described further herein. In some embodiments, the processor 202 includes hardware, software, firmware, and/or a combination thereof, that generates and/or receives data including one or more portions of vehicle performance data, vehicle sensor data, environmental data, logistical data, emergency flight plan data, 3D protected zone data, and/or other data related to one or more adverse situations impacting the operation of a vehicle (e.g., an aerial vehicle 112).

Additionally or alternatively, in some embodiments, the processor 202 includes hardware, software, firmware, and/or a combination thereof, that causes rendering a 3D protected zone and/or information associated therewith via one or more electronic interfaces associated with the vehicle apparatus 200 and/or one or more electronic interfaces associated with other computing devices (e.g., a vehicle operations center apparatus associated with the vehicle operations center). Additionally or alternatively, in some embodiments, the processor 202 includes hardware, software, firmware, and/or a combination thereof, that in real-time updates rendering of a user interface and/or interface element(s) thereof in response to updated data related to the one or more adverse situations, one or more 3D protected zones associated with the one or more adverse situations, and/or one or more portions of data associated with the operation of the aerial vehicle 112.

In some embodiments, the vehicle apparatus 200 includes input/output circuitry 206 that provides output to the user and, in some embodiments, to receive an indication of a user input (e.g., user input generated by a pilot, operator, crew member, and/or passenger). In some embodiments, the input/output circuitry 206 is in communication with the processor 202 to provide such functionality. The input/output circuitry 206 in some embodiments comprises one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202, and/or input/output circuitry 206 comprising a processor, in some embodiments is configured to control one or more functions of one or more user interface elements through computer program instructions (e.g., software and/or firmware) stored on a memory accessible to the processor 202 (e.g., memory 204, and/or the like). In some embodiments, the input/output circuitry 206 includes or utilizes a user-facing application to provide input/output functionality to a computing device and/or other display associated with a user. In some embodiments, the input/output circuitry 206 includes a cockpit display, a navigation map display, a PFD, an HUD, a VSD, a Near-to-Eye display, an AR display, a VR display, and/or another type of display onboard an aerial vehicle or integrated as a part of a remote platform. Additionally or alternatively, in some embodiments, the input/output circuitry 206 includes one or more software-rendered user interface(s) including interface element(s) that depict particular data and/or information, and/or that receive user input.

The communications circuitry 208 includes any means such as a device or circuitry embodied in either hardware or a combination of hardware and software that is configured to receive and/or transmit data from/to a communications network and/or any other computing device, circuitry, or module in communication with the vehicle apparatus 200. In this regard, the communications circuitry 208 includes, for example in some embodiments, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from one or more computing device(s) and/or system(s) of other connected vehicle system(s) 104, vehicle operation management system(s) 106, and/or environment data system(s) 108, in communication with the vehicle apparatus 200.

The sensor(s) 210 includes hardware, software, firmware, and/or a combination thereof, that supports generation, capturing, aggregating, retrieval, and/or receiving of one or more portions of sensor data. In some embodiments, the sensor(s) 210 includes one or more discrete component(s) of a vehicle (e.g., an aerial vehicle 112). The sensor(s) 210 in some embodiments are affixed to, within, and/or otherwise as a part of an aerial vehicle including or otherwise associated with the vehicle apparatus 200. For example, in some embodiments, one or more of the sensor(s) 210 is/are mounted to the aerial vehicle, such as the aerial vehicle 112. Non-limiting examples of sensor(s) 210 include altimeter(s) (e.g., radio and/or barometric), pressure sensor(s), pilot tube(s), anemometer(s), image camera(s), video camera(s), infrared sensor(s), speed sensor(s), battery sensor(s), fuel level sensor(s), biological sensor(s) and/or the like. In some embodiments, the sensor(s) 210 are integrated with, or embodied by, one or more of the aerial vehicle onboard system(s) 102 such that the sensor(s) 210 generate, collect, monitors, and/or otherwise obtain data related to the one or more aerial vehicle onboard system(s) 102.

In some embodiments, the sensor(s) 210 additionally or alternatively include any of a myriad of sensor(s) conventionally associated with drone(s), helicopter(s), and/or other urban air mobility aerial vehicle(s). Additionally or alternatively, in some embodiments, the sensor(s) 210 include one or more high-sensitivity sensor(s) to facilitate enable high accuracy capturing of data in certain circumstances. For example, in some embodiments, the sensor(s) 210 includes one or more high-sensitivity sensor(s) that capture detailed data while an aerial vehicle is in flight. Such higher fidelity sensor(s) in some embodiments supplement and/or, in other embodiments, replace the data captured by such sensor(s) with lower fidelity.

In some embodiments, the sensor(s) 210 includes hardware, software, firmware, and/or a combination thereof, embodying one or more navigation sensor(s). In some embodiments, the navigation sensor(s) includes a global positioning satellite (GPS) tracking chip and/or the like enabling location services to be requested and/or determined for a particular aerial vehicle. Additionally or alternatively, in some embodiments, the sensor(s) 210 includes hardware, software, firmware, and/or any combination thereof, embodying inertial navigation sensor(s) that measures speed, acceleration, orientation, and/or position-related data in a 3D environment. Additionally or alternatively, in some embodiments, the sensor(s) 210 includes one or more camera(s) associated with a synthetic vision system (SVS). In some such embodiments, such an SVS camera captures image data representation(s) of the real-world environment around an aerial vehicle for use in generating corresponding user interface(s) depicting he captured image data, augmenting such image data, and/or otherwise providing data to enable an operator to acquire situational awareness based at least in part on the captured image data. It will be appreciated that, in some embodiments, the sensor(s) 210 includes a separate processor, specially configured field programmable gate array (FPGA), or a specially programmed application specific integrated circuit (ASIC).

The vehicle control circuitry 212 includes hardware, software, firmware, and/or a combination thereof, that supports functionality associated with navigating and/or controlling a vehicle (e.g., an aerial vehicle 112). In some embodiments, vehicle control circuitry 212 can control and/or configure one or more of the aerial onboard system(s) 102. In some embodiments, vehicle control circuitry 212 includes hardware, software, firmware, and/or a combination thereof, that receives flight plan data (e.g., embodying a flight plan), location service(s) data representing a location of an aerial vehicle 112, and/or the like. Additionally or alternatively, in some embodiments, the vehicle control circuitry 212 includes hardware, software, firmware, and/or a combination thereof, that depicts interface element(s) representing at least a flight path or indication where the aerial vehicle 112 is currently traveling and/or should travel.

Additionally or alternatively, in some embodiments, the vehicle control circuitry 212 includes hardware, software, firmware, and/or a combination thereof, that autonomously control(s) one or more component(s) of an aerial vehicle. In some such embodiments, the vehicle control circuitry 212 autonomously control(s) one or more physical component(s) of a vehicle (e.g., an aerial vehicle 112) to facilitate movement of the vehicle along a particular path. Alternatively or additionally, in some embodiments, the vehicle control circuitry 212 includes hardware, software, firmware, and/or a combination thereof, that semi-autonomously control(s) one or more component(s) of an aerial vehicle, for example where certain aspects of the operation of the aerial vehicle are autonomously performed and others (e.g., directional control) is/are controlled by a user (e.g., a pilot). Alternatively or additionally, in some embodiments, the vehicle control circuitry 212 includes hardware, software, firmware, and/or a combination thereof, that receives pilot input for controlling one or more component(s) of an aerial vehicle, for example via vehicle flight control(s) to alter speed and/or direction of the aerial vehicle. Alternatively or additionally, in some embodiments, the vehicle control circuitry 212 includes hardware, software, firmware, and/or a combination thereof, that causes changes to an operational mode (e.g., an economy mode) of an aerial vehicle, for example autonomously based at least in part on one or more data-driven adverse situation(s) and/or triggers, or in response to user input initiating the change in operational mode. In some embodiments, the vehicle control circuitry 212 includes hardware, software, firmware, and/or a combination thereof, that controls one or more component(s) of an aerial vehicle based on a flight path associated with an emergency flight plan and/or a 3D protected zone. It will be appreciated that, in some embodiments, the vehicle control circuitry 212 includes a separate processor, specially configured field programmable gate array (FPGA), or a specially programmed application specific integrated circuit (ASIC).

The 3D protected zone circuitry 214 includes hardware, software, firmware, and/or a combination thereof, that supports functionality associated with generating, broadcasting, and/or otherwise managing a 3D protected zone for a vehicle (e.g., an aerial vehicle 112). For example, the 3D protected zone circuitry 214 can execute, at least in part, one or more portions of program code for generating a 3D protected zone around a flight path for the aerial vehicle 112 associated with an emergency operations event. In various embodiments, the 3D protected zone circuitry 214 generates the 3D protected zone based on emergency flight plan data for the aerial vehicle 112. In various embodiments, the 3D protected zone circuitry 214 determines the emergency flight plan data based on one or more portions of data input comprising vehicle performance data, vehicle sensor data, vehicle operation data, vehicle system data, air traffic data, environmental data, logistical data, personnel data, and/or any other relevant data related to the aerial vehicle 112. In various embodiments, the emergency flight plan data includes an emergency flight path of the aerial vehicle 112, an emergency destination location of the aerial vehicle 112, and/or other information related to an emergency flight plan for the aerial vehicle 112.

In various embodiments, the 3D protected zone circuitry 214 configures the 3D protected zone for rendering via a display of the aerial vehicle 112 and/or one or more different aerial vehicles. For example, the 3D protected zone circuitry 214 can configure the 3D protected zone for rendering via a display associated with the aerial vehicle onboard system 102 and/or the other connected vehicle system 104. In various embodiments, the 3D protected zone circuitry 214 causes rendering of a graphical element associated with the 3D protected zone via a display of one or more different aerial vehicle. The display can be a primary flight display and/or a vertical situation display of the one or more different aerial vehicle. In various embodiments, the 3D protected zone circuitry 214 additionally or alternatively causes rendering of a graphical element associated with the 3D protected zone via a display of a display of a remote operations platform.

In various embodiments, the 3D protected zone circuitry 214 determines a mode of communication for the broadcasting the 3D protected zone and the emergency flight plan data. The mode of communication can be wireless communication, satellite communication, LEO satellite communication, or another mode of communication. In response to the aerial vehicle 112 arriving at a designated location, the 3D protected zone circuitry 214 additionally or alternatively broadcasts a removal indicator for the 3D protected zone and the emergency flight plan data to the one or more different aerial vehicles. In various embodiments, the 3D protected zone circuitry 214 receives, from one or more different aerial vehicles, an acceptance indicator for the 3D protected zone in response to a user action with respect to an interactive graphical element rendered via a display of the one or more different aerial vehicles.

It will be appreciated that, further in some embodiments, two or more of the sets of circuitries 202-214 are combinable. Alternatively or additionally, in some embodiments, one or more of the sets of circuitry 202-214 perform some or all of the functionality described associated with another component. For example, in some embodiments, one or more of the sets of circuitry 202-214 are combined into a single component embodied in hardware, software, firmware, and/or a combination thereof. For example, in some embodiments, two or more of the vehicle control circuitry 212 and 3D protected zone circuitry 214 are embodied by a single set of circuitry that performs the combined operations of the individual sets of circuitry. Similarly, in some embodiments, one or more of the sets of circuitry, for example vehicle control circuitry 212 and/or 3D protected zone circuitry 214 is/are combined with the processor 202, such that the processor 202 performs one or more of the operations described above with respect to each of these other sets of circuitry.

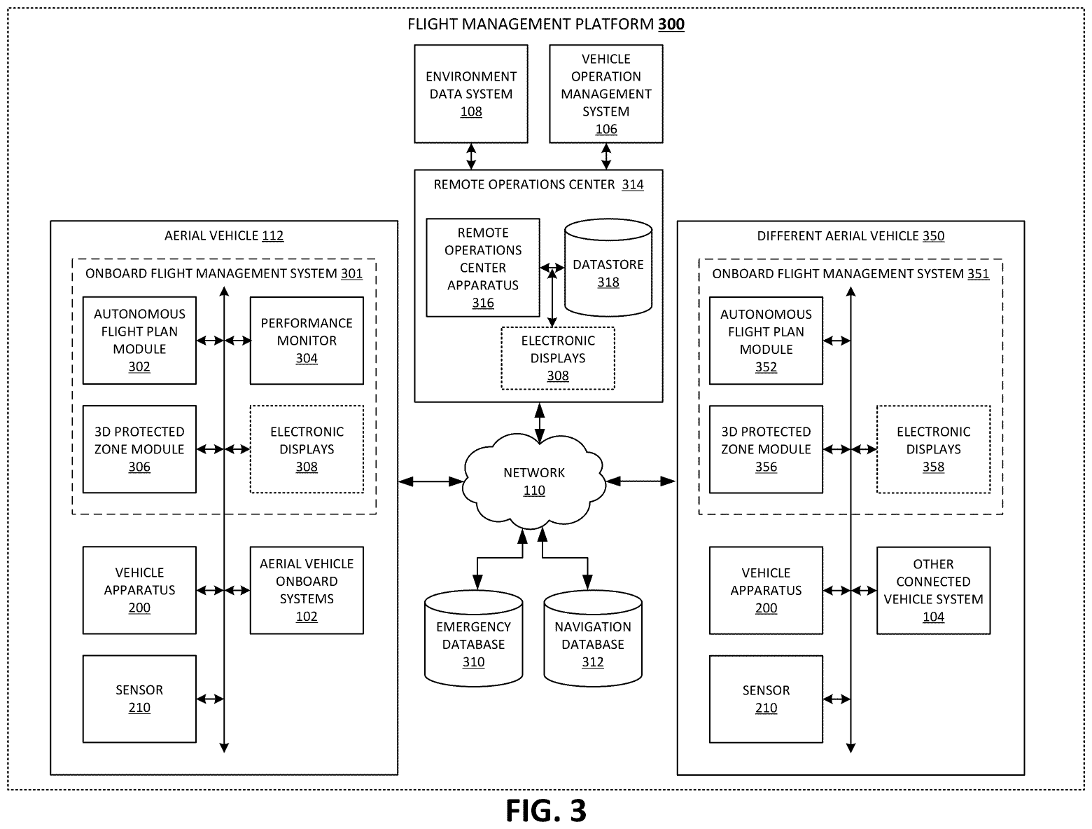

FIG. 3 illustrates an example flight management platform 300 in accordance with at least some example embodiments of the present disclosure. As depicted, FIG. 3 depicts various operational services, systems, components, apparatuses, and datastores embodied by the flight management platform 300. For example, the flight management platform 300 includes remote operations center 314 comprising a remote operations center apparatus 316 and/or a datastore 318. In various embodiments, the remote operations center 314 integrates and/or communicates with one or more environment data system(s) 108 and/or one or more vehicle operation management system(s) 106. In various embodiments, the remote operations center 314, environment data system(s) 108, and/or the vehicle operation management system(s) 106 in some embodiments communicate via the network 110.

The flight management platform 300 also comprises an onboard flight management system 301 embodied by the aerial vehicle 112. In various embodiments, the onboard flight management system 301 in some embodiments is integrates with, or is embodied by, the vehicle apparatus 200. Additionally or alternatively, in various embodiments, the onboard flight management system 301 integrates with the aerial vehicle onboard system 102 and/or the sensors 210 associated with the aerial vehicle 112. In various embodiments, the remote operations center 314 communicates with the onboard flight management system 301 via the network 110. For example the remote operations center 314 communicates with the onboard flight management system 301 through one or more of the component parts of the remote operations center apparatus 316 (e.g., communications circuitry) and one or more component parts of the vehicle apparatus 200 (e.g., communications circuitry 208) via the network 110. The onboard flight management system 301 of a respective vehicle (e.g., an aerial vehicle 112) comprises an autonomous flight plan module 302, a performance monitor 304, a 3D protected zone module 306, and/or one or more electronic displays 308.

As will be further detailed herein, due to the distributed nature of the various embodiments of the present disclosure, the flight management platform 300 and the operational systems and/or services comprised therein in some embodiments is configured to freely pass data via one or more communications networks (e.g., network 110) in order to optimally delegate one or more operations described herein to one or more respective computing devices associated with the flight management platform 300. This delegation of operations provides the benefit of optimizing the capabilities of a particular vehicle (e.g., a particular aerial vehicle 112) based at least in part on the processing power associated with the particular vehicle. As will be appreciated, the delegation of certain methods, procedures, calculations, computations, configurations, predictions, and/or the like throughout the distributed operational systems and/or services of the flight management platform 300 reduces the load on the aerial vehicle onboard system(s) 102 of the vehicle as well as the load on the computing devices (e.g., the remote operations center apparatus 316) of the remote operations center 314.

The flight management platform 300 comprises many data storage systems deployed in various configurations. As defined herein, database (e.g., emergency database 310 and navigation database 312) and/or datastore (e.g., datastore 318) in some embodiments is any type of non-transitory computer-readable storage medium. Non-limiting examples include hardware, software, firmware, and/or a combination thereof capable of storing, recording, updating, retrieving and/or deleting computer-readable data and information related to the flight management platform 300. In various embodiments, a database (e.g., emergency database 310 and navigation database 312) and/or datastore (e.g., datastore 318) in some embodiments is a cloud-based storage system accessible via a communications network (e.g., the network 110) by one or more components of the various embodiments of the present disclosure.

The remote operations center apparatus 316 in some embodiments is a computing apparatus configured to generate one or more interactive user interfaces for rendering on one or more electronic displays associated with the remote operations center 314. For example, in some embodiments, the remote operations center apparatus 316 is configured to generate an interactive user dashboard comprising various interactive interface elements representing data related to the flight management platform 300, data related to one or more onboard flight management system(s) 301, data related to one or more vehicles (e.g., one or more aerial vehicle(s) 112), data related to the one or more system(s) integrated with the remote operations center 314, and/or data related to the one or more storage system(s) associated with the flight management platform 300.

As such, the remote operations center apparatus 316, via the one or more interactive user interfaces, is configured to initialize, configure, update, modify, and/or otherwise set up an onboard flight management system 301 associated with a particular vehicle (e.g., aerial vehicle 112). Additionally or alternatively, the remote operations center apparatus 316, via the one or more interactive user interfaces, is configured to initialize, configure, update, modify, and/or otherwise set up one or more components associated with a particular onboard flight management system 301 such as, for example, the autonomous flight plan module 302, the performance monitor 304, the 3D protected zone module 306, and/or the electronic displays 308.

The datastore 318 associated with the remote operations center 314 in some embodiments is configured to store, retrieve, configure, modify, and/or otherwise manage one or more portions of data related to the flight management platform 300. For instance, the datastore 318, in some embodiments, stores vehicle performance data, adverse situation mitigation data, vehicle operation data associated with one or more vehicles, and/or one or more portions of training data for training and/or re-training the various models associated with the onboard flight management system 301 (e.g., the vehicle performance prediction model). Additionally, the datastore 318 in some embodiments stores one or more portions of data associated with the environment data system(s) 108 and/or the vehicle operation management system(s) 106.

Furthermore, the datastore 318 is configured to store one or more portions of data related to one or more vehicles associated with a vehicle fleet related to the flight management platform 300. For example, the datastore 318 in some embodiments stores one or more vehicle identifiers, vehicle load identifiers, vehicle component identifiers, onboard flight management system identifiers, vehicle fleet data, vehicle mission data, and/or any other data pertinent to the one or more vehicles in a vehicle fleet associated with the flight management platform 300. Additionally, the datastore 318 can store one or more portions of personnel data related to one or more vehicle operators, vehicle pilots, vehicle crew members, ground crew members, management personnel, and/or passengers associated with the flight management platform 300.

The onboard flight management system 301, in some embodiments, integrates with, or can be embodied by, a computing device such as a line replaceable unit (LRU). For example, the onboard flight management system 301 in some embodiments is embodied by an aerospace gateway LRU configured to communicate with one or more vehicle system(s). The remote operations center 314 and one or more onboard flight management system(s) 301 associated with one or more respective vehicles remain in constant communication and are configured to transmit and/or receive data related to the operation of the one or more vehicles via a communications network (e.g., network 110). In this regard, the onboard flight management system 301 in some embodiments generates and transmits one or more requests to the remote operations center 314 via the communications network. The one or more requests include, but are not limited to, a request for one or more portions of data including, but not limited to, environmental data, vehicle operation management data, vehicle data, logistics data, hazard data, air traffic data, road traffic data, and/or the like.

Additionally, the onboard flight management system 301 is configured to log and/or transmit one or more portions of data related to the vehicle to the remote operations center 314. For example, the onboard flight management system 301 is configured to transmit one or more portions of vehicle performance data related to the real-time performance (e.g., the performance of a battery system) of a respective vehicle. Additionally or alternatively, the onboard flight management system 301 is configured to transmit one or more portions of data related to a predicted energy expenditure of the vehicle based at least in part on a trip plan associated with the vehicle.

In various embodiments, the onboard flight management system 301 is configured to execute an emergency flight plan process by calculating an impact of one or more flight plan parameters on the one or more vehicle systems associated with a respective vehicle (e.g., the aerial vehicle 112), where the one or more trip parameters comprise at least one of a vehicle type, a vehicle battery system, a number of passengers, a vehicle payload weight, and/or one or more environmental factors. Additionally, the onboard flight management system 301 can receive one or more flight plans associated with a respective vehicle. The onboard flight management system 301 is configured to determine, based on inputting results from the vehicle performance validation process and a particular flight plan into the 3D protected zone module 306, whether the particular flight plan is feasible. In various embodiments, determining whether the particular flight plan is feasible comprises correlating the particular flight plan and/or the results from the vehicle performance validation process with one or more current values associated with one or more aerial vehicle parameters associated with the aerial vehicle 112.

The performance monitor 304 is an ML model that is specially configured to receive one or more portions of vehicle operation data (e.g., data related to one or more battery parameters) and, based at least in part on the one or more portions of vehicle operation data, generate one or more portions of vehicle performance data describing one or more operational states of the vehicle. Additionally, the performance monitor 304 associated with an onboard flight management system 301 is configured to identify, classify, categorize, and/or analyze one or more adverse situations impacting the operation of a vehicle.

The performance monitor 304 determines whether the vehicle is in a nominal state (e.g., a nominal operational state) or an adverse state (e.g., an adverse operational state). The performance monitor 304 in some embodiments generates one or more portions of model output (e.g., vehicle performance data) configured to describe the current status, energy expenditure, operational parameters, data values, operational modes, and/or configurations of one or more vehicle systems associated with the vehicle. In this regard, if the performance monitor 304 determines that one or more adverse situations are taking place that are impacting the operation of the vehicle, the performance monitor 304 determines how the one or more adverse situations are related to (e.g., how the one or more adverse situations are impacting) the respective vehicle systems (e.g., a battery system, a control system, and/or another system of the vehicle).

As such, the performance monitor 304 generates one or more portions of vehicle performance data related to the current operational status of the vehicle as model output. The one or more portions of vehicle performance data are one or more portions of data that have been configured for logging, analysis, ML model input, ML model training, and/or storage. For example, one or more portions of vehicle performance data in some embodiments captures the nominal state (e.g., nominal state) of the vehicle by logging, storing, and/or otherwise saving a current configuration of the one or more vehicle systems as well as how the configuration of the one or more vehicle systems relates to the current nominal operation of the vehicle. Similarly, the performance monitor 304 in some embodiments generates one or more portions of vehicle performance data capturing an adverse state (e.g., an adverse operational state) related to one or more adverse situations impacting the operation of the vehicle and the respective vehicle systems associated with the vehicle.

Vehicle performance data associated with a nominal state of a particular vehicle in some embodiments is used in one or more data recovery operations for reverting the particular vehicle from an adverse state back into a nominal state. For example, the vehicle performance data associated with the nominal state in some embodiments comprises one or more operational parameters, data values, operational modes, and/or configurations of one or more vehicle systems. As such, the vehicle performance data associated with the nominal state in some embodiments is utilized to reconfigure, re-initialize, and/or otherwise update the one or more vehicle systems such that the vehicle resumes operating in a manner congruent with the corresponding nominal state. In various embodiments, one or more portions of data related to the current operational state of the vehicle, one or more portions of vehicle performance data, and/or any data generated and/or managed by the performance monitor 304 in some embodiments is rendered via one or more computing device(s) associated with the remote operations center 314.

Furthermore, in various embodiments, the performance monitor 304 in some embodiments is configured to classify the criticality of one or more adverse situations associated with a vehicle (e.g., an aerial vehicle 112). For instance, once the performance monitor 304 determines that one or more adverse situations that can impact the operation of the vehicle is occurring, the performance monitor 304 determines an adverse situation severity level associated with the one or more adverse situations. As a non-limiting example, the performance monitor 304 in some embodiments classifies one or more adverse situations as having a low severity level, a moderate severity level, a high severity level, a critical severity level, and/or the like. In various embodiments, one or more adverse situation severity thresholds in some embodiments are predetermined and incorporated by the vehicle performance prediction model such that when a respective adverse situation severity level associated with the one or more adverse situations satisfies the one or more adverse situation severity thresholds, the vehicle performance prediction model generates one or more recommendations to address the one or more adverse situations.

As a non-limiting example, in response to determining that an adverse situation associated with a moderate severity level is impacting the operation of the vehicle (e.g., one or more battery cells associated with the battery system is beginning to overheat), the onboard flight management system 301 may generate a recommendation to cause the vehicle to execute an emergency navigation procedure that navigates the vehicle to an optimal travel hub via an optimal route. As another non-limiting example, in response to determining that an adverse situation associated with a high severity level is impacting the operation of the vehicle (e.g., a failure of a particular vehicle system), the onboard flight management system 301 may generate a recommendation to cause the vehicle to execute an emergency navigation procedure that navigates the vehicle to a designated location.

The performance monitor 304 in some embodiments determines a respective adverse situation type associated with one or more adverse situations impacting the operation of the vehicle. One or more adverse situation types in some embodiments are determined based in part on one or more portions of vehicle performance data indicative of a nominal scenario, an emergency scenario, a hazard scenario, a scenario that alters the voyage of the aerial vehicle, and/or a change in the operation of a system affecting control of the aerial vehicle. In various embodiments, at least a portion of the vehicle performance data is based at least in part on vehicle sensor data collected, measured, calculated, and/or otherwise generated by one or more sensors (e.g., one or more sensors 210) associated with the vehicle.

A few non-limiting examples of adverse situation types that in some embodiments is associated with a respective adverse situation include, an emergency adverse situation type, a hazard adverse situation type, a mechanical failure adverse situation type, a logistical adverse situation type, an environmental adverse situation type, an optimization adverse situation type, a personnel health adverse situation type, and/or the like. In some embodiments, adverse situation types in some embodiments are associated with a predefined adverse situation severity level. For example, in some embodiments, a logistical adverse situation type in some embodiments is automatically associated with a low severity level. However, the performance monitor 304 in some embodiments determines that a particular adverse situation associated with a logistical adverse situation type has a high adverse situation severity level due to various respective circumstances.

The performance monitor 304 is configured to cause rendering of one or more portions of data related to the current state of a vehicle (e.g., the aerial vehicle 112) via, for example, the vehicle apparatus 200 and/or the remote operations center apparatus 316. For example, the performance monitor 304 is configured to cause rendering of one or more portions of data related to a nominal state of the vehicle, data related to an adverse state of the vehicle, data related to the one or more adverse situations impacting the operation of the vehicle, data related to the vehicle performance data associated with the vehicle, data related to the vehicle sensor data associated with the vehicle, and/or the like.

Furthermore, the performance monitor 304 is configured to generate one or more alerts, warnings, notifications, and/or prompts related to the one or more portions of data related to the current state of a vehicle (e.g., the aerial vehicle 112). The performance monitor 304 cause rendering of the one or more alerts, warnings, notifications, and/or prompts via, for example, the vehicle apparatus 200 and/or the remote operations center apparatus 316. For example, the performance monitor 304 in some embodiments generates an alert detailing that a particular aerial vehicle 112 has entered into an adverse state. The alert in some embodiments details the problem sate, the one or more adverse situations impacting the operation of the vehicle, and/or the one or more vehicle systems (e.g., aerial vehicle onboard system(s) 102) that have been affected by the adverse state and/or the one or more adverse situations. In various embodiments, the performance monitor 304 is configured to generate or more alerts, warnings, notifications, and/or prompts related to an emergency operations event to facilitate generation of a 3D protected zone for the aerial vehicle.

The performance monitor 304 is also configured to transmit data related to one or more portions of vehicle performance data, data related to one or more adverse situations, and/or data related to one or more operational states to the vehicle performance prediction model comprised within the 3D protected zone module 306 to facilitate the mitigation of one or more adverse situations impacting the corresponding vehicle (e.g., the aerial vehicle 112).

The 3D protected zone module 306 comprises hardware, software, firmware, and/or a combination thereof associated with an onboard flight management system 301 that is configured to generate a 3D protected zone around a flight path for an aerial vehicle associated with an emergency operations event based on data provided by the performance monitor 304.

The electronic displays 308 associated with the onboard flight management system 301 may comprise, in various embodiments, one or more cockpit displays, one or more vertical situation displays (VSDs), one or more PFDs, one or more displays associated with an FMS, one or more displays associated with a navigation system, one or more displays associated with one or more respective LRUs, one or more computer displays, and/or the like. In various embodiments, the one or more electronic displays 308 can be associated with one or more computing devices associated with the remote operations center 314.

The emergency database 310 is configured to store and/or manage one or more portions of data related to emergency flight plan data, vehicle operation data, vehicle performance data, vehicle sensor data, adverse situation data, nominal state data, adverse state data, and/or the like associated with one or more current or previously executed trip plans associated with one or more respective vehicles (e.g., aerial vehicles 112) associated with the flight management platform 300. In various embodiments, the emergency database 310 can receive one or more portions of data from a particular vehicle (e.g., an aerial vehicle 112) via the network 110. Furthermore, the one or more portions of aforementioned data can be associated with a vehicle identifier of a respective vehicle (e.g., an aerial vehicle 112). As such, the one or more portions of data comprised in the emergency database 310 can be used to generate a 3D protected zone via the 3D protected zone module 306 of the respective vehicle.

The navigation database 312 is configured to store and/or manage one or more portions of data related to one or more travel hubs, one or more travel routes, one or more waypoints, one or more destinations, one or more locations, one or more environmental features, one or more obstacles, and/or one or more portions of logistical information that may impact, aid, facilitate, enhance, and/or otherwise pertain to one or more trip plans associated with one or more respective vehicles associated with the flight management platform 300. Furthermore, the navigation database 312, in various embodiments, is configured to store and/or manage one or more portions of data associated with the environment data systems 108 and/or the vehicle operation management systems 106.

In various embodiments, the emergency database 310 and/or the navigation database 312 can be configured as cloud-based storage systems. As such, the one or more portions of data comprised in the emergency database 310 and/or the navigation database 312 can be accessed, retrieved, updated, and/or managed by the vehicle apparatus 200 via the network 110. Additionally or alternatively, in various embodiments, the one or more portions of data comprised in the emergency database 310 and/or the navigation database 312 can be accessed, retrieved, updated, and/or managed by the remote operations center apparatus 316 via the network 110. Additionally or alternatively, the one or more portions of data comprised in the emergency database 310 and/or the navigation database 312 can, in various embodiments, be stored locally in the vehicle apparatus 200 and/or the remote operations center apparatus 316.

As described herein, in various embodiments, the flight management platform 300 comprises a remote operations center 314 configured for the offboard management and control of a fleet of vehicles associated with an enterprise. In this regard, the flight management platform 300 is configured as a distributed management system such that one or more vehicles integrate with a respective onboard flight management system 301 communicably coupled to the remote operations center 314. The remote operations center 314, in conjunction with a particular instance of the onboard flight management system 301 associated with a particular vehicle (e.g., an aerial vehicle 112), is configured to monitor, manage, and/or improve the performance of the particular vehicle by providing data to one or more operators associated with the particular vehicle. The remote operations center 314 and one or more onboard flight management system(s) 301 associated with one or more respective vehicles remain in constant contact and are configured to transmit and/or receive data related to the operation of the one or more vehicles via the network 110. The remote operations center 314 comprises one or more computing device(s) (e.g., the remote operations center apparatus 316), one or more machine learning (ML) model(s), and/or one or more datastore(s) (e.g., the datastore 318) configured to monitor and/or manage one or more vehicles.

In various embodiments, the onboard flight management system 301 associated with a respective vehicle (e.g., an electric aerial vehicle) can transmit one or more portions of data to the remote operations center 314 via the network 110. For example, the onboard flight management system 301 can be configured to transmit one or more portions of data related to a current energy expenditure of the vehicle, one or more current values associated with one or more respective battery parameters associated with a battery system of the vehicle, data related to an adverse situation, and/or the like. In this regard, in various embodiments, the remote operations center apparatus 316 of the remote operations center 314 can be configured to execute one or more operations associated with the onboard flight management system 301. For example, in various embodiments such as, for example, when an electric aerial vehicle is completely autonomous, the remote operations center apparatus 316 can be configured to perform at least a portion of the processing associated with the onboard flight management system 301 associated with the electric aerial vehicle. As such, the computational resources needed by the electronic aerial vehicle may be advantageously reduced.

In one or more embodiments, the flight management platform 300 additionally includes a different aerial vehicle 350. The different aerial vehicle 350 can be an aerial vehicle in connectivity range with respect to the aerial vehicle. For example, the different aerial vehicle 350 can be an aerial vehicle in connectivity range with respect to the aerial vehicle via wireless communication, satellite communication, LEO satellite communication, or another mode of communication. In one or more embodiments, the different aerial vehicle 350 can receive a 3D protected zone and/or emergency flight plan data from the aerial vehicle 112 via the network 110. Additionally, the 3D protected zone can be rendered via one or more displays of the different aerial vehicle 350.

In one or more embodiments, the flight management platform 300 comprises an onboard flight management system 351 embodied by the different aerial vehicle 350. In various embodiments, the onboard flight management system 351 in some embodiments is integrates with, or is embodied by, the vehicle apparatus 200. Additionally or alternatively, in various embodiments, the onboard flight management system 351 integrates with the other connected vehicle system 104 and/or the sensors 210 associated with the different aerial vehicle 350. In one or more embodiments, the onboard flight management system 351 comprises an autonomous flight plan module 352, a 3D protected zone module 356, and/or one or more electronic displays 358.

In various embodiments, the autonomous flight plan module 352 is configured to execute an emergency flight plan based on the 3D protected zone provided by the aerial vehicle 112. For example, the 3D protected zone module 356 can receive the 3D protected zone from the aerial vehicle 112. In certain embodiments, the 3D protected zone module 356 can cause rendering of the 3D protected zone via one or more of the electronic displays 358 in response to a user action with respect to an interactive graphical element rendered via one or more of the electronic displays 358. In other embodiments, the 3D protected zone module 356 can cause rendering of the 3D protected zone via one or more of the electronic displays 358 in response to a certain interval of time being realized since receiving the 3D protected zone from the aerial vehicle 112. For example, if a certain amount of time has passed since receiving the 3D protected zone from the aerial vehicle 112, the 3D protected zone module 356 can autonomously cause rendering of the 3D protected zone via one or more of the electronic displays 358. The electronic displays 358 associated with the onboard flight management system 351 may comprise, in various embodiments, one or more cockpit displays, one or more vertical situation displays (VSDs), one or more PFDs, one or more displays associated with an FMS, one or more displays associated with a navigation system, one or more displays associated with one or more respective LRUs, one or more computer displays, and/or the like.

### OPERATIONAL EXAMPLES OF VARIOUS EMBODIMENTS OF THE DISCLOSURE

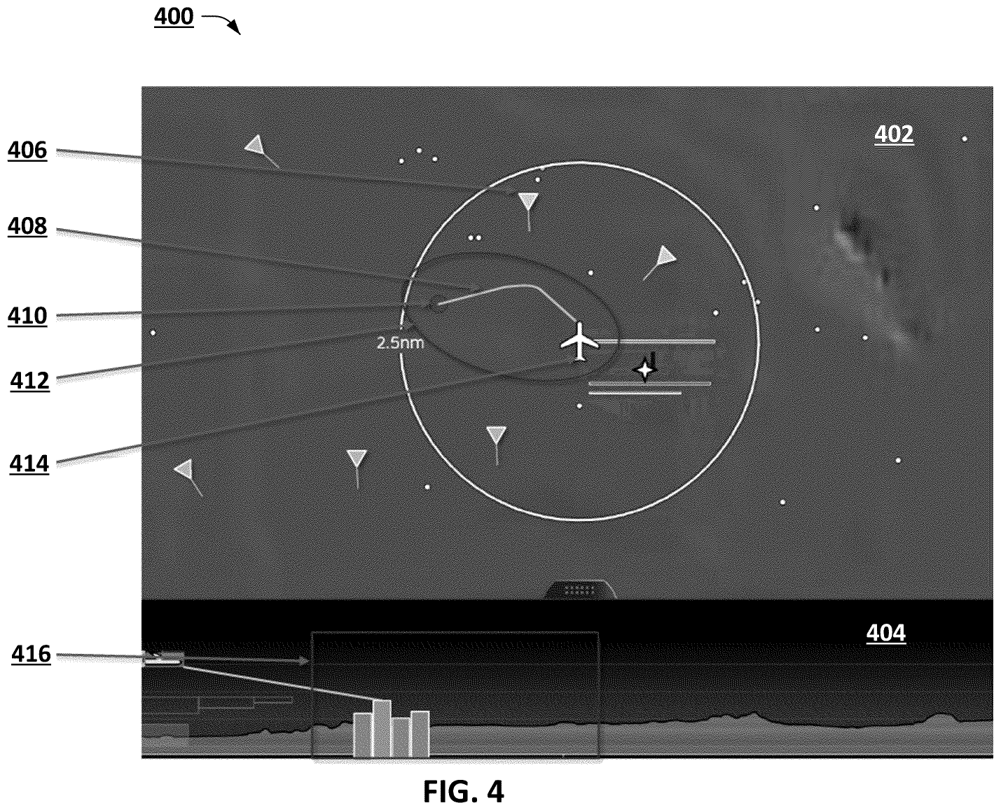

FIG. 4 illustrates an operational example of an electronic display configured to display one or more predicted energy overlays in accordance with at least some example embodiments of the present disclosure. Specifically, FIG. 4 illustrates a configuration of an electronic display 400. In various embodiments, the electronic display 400 may be an electronic display associated with one or more of a PFD, a VSD, an FMS, a vehicle apparatus 200, a remote operations center apparatus 316, and/or one or more other computing devices associated with the flight management platform 300. In various embodiments, the electronic display 400 can be rendered via one or more electronic displays associated with the aerial vehicle 112 (e.g., electronic displays 308) and/or the remote operations center (e.g., the electronic displays 308).

As shown in FIG. 4, the electronic display 400 is configured to display a plurality of interface elements associated with a flight plan being executed by an aerial vehicle such as the aerial vehicle 112 or the different aerial vehicle 350. The electronic display 400 is divided into an electronic map 402 and a VSD 404. The electronic map 402 can be, for example, a primary flight display of the aerial vehicle that provides an overhead view for depicting waypoints, designated locations, flight path data, and/or 3D protected zone data. Additionally the VSD 404 can provide a horizontal distance scale view for depicting a profile or side view of terrain, flight path data, and/or 3D protected zone data.

As depicted in FIG. 4, the electronic map 402 includes an overlay 406 representing a different aerial vehicle potentially affecting emergency operation for the aerial vehicle, an overlay 408 representing an emergency flight path for the aerial vehicle, an overlay 410 representing a designated location for the aerial vehicle, an overlay 412 representing a 3D protected zone for the aerial vehicle, and/or an overlay 414 representing a real-time location of the aerial vehicle (e.g., the aerial vehicle 112). Additionally, as depicted in FIG. 4, the VSD 404 includes an overlay 416 representing another rending of the 3D protected zone for the aerial vehicle. As seen in FIG. 4, the 3D protected zone for the aerial vehicle includes 3D dimensionality related to altitude, latitude and/or longitude.

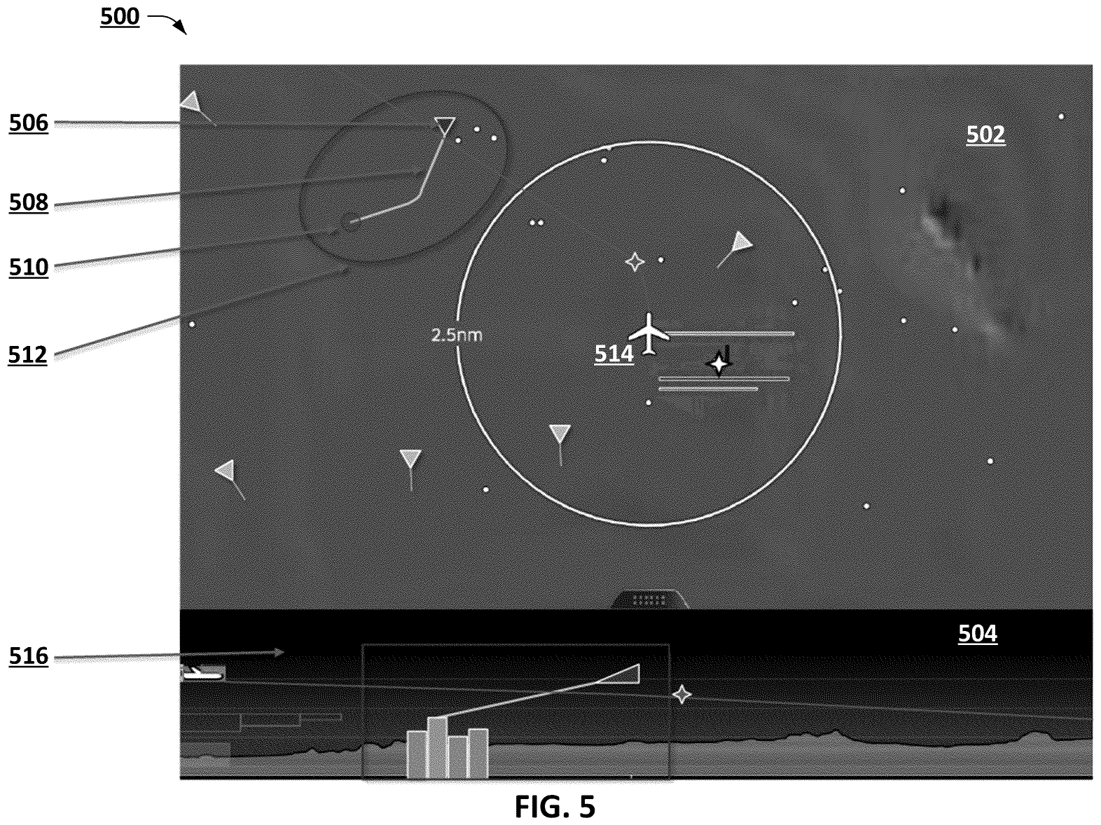

FIG. 5 illustrates an operational example of an electronic display configured to display one or more predicted energy overlays in accordance with at least some example embodiments of the present disclosure. Specifically, FIG. 5 illustrates a configuration of an electronic display 500. In various embodiments, the electronic display 500 may be an electronic display associated with one or more of a PFD, a VSD, an FMS, a vehicle apparatus 200, a remote operations center apparatus 316, and/or one or more other computing devices associated with the flight management platform 300. In various embodiments, the electronic display 500 can be rendered via one or more electronic displays associated with the different aerial vehicle 350 (e.g., the electronic displays 358).

As shown in FIG. 5, the electronic display 500 is configured to display a plurality of interface elements associated with a flight plan being executed by an aerial vehicle such as the aerial vehicle 112 or the different aerial vehicle 350. The electronic display 500 is divided into an electronic map 502 and a VSD 504. The electronic map 502 can be, for example, a primary flight display of the aerial vehicle that provides an overhead view for depicting waypoints, designated locations, flight path data, and/or 3D protected zone data. Additionally the VSD 504 can provide a horizontal distance scale view for depicting a profile or side view of terrain, flight path data, and/or 3D protected zone data.

As depicted in FIG. 5, the electronic map 502 includes an overlay 506 representing an aerial vehicle (e.g., the aerial vehicle 112) associated with the emergency operations event, an overlay 508 representing an emergency flight path for an aerial vehicle associated with the emergency operations event, an overlay 510 representing a designated location for an aerial vehicle associated with the emergency operations event, and/or an overlay 512 representing a 3D protected zone for an aerial vehicle associated with the emergency operations event. The electronic map 502 also includes an overlay 514 representing a real-time location of the aerial vehicle (e.g., the different aerial vehicle 352). Additionally, as depicted in FIG. 5, the VSD 504 includes an overlay 516 representing another rending of the 3D protected zone for the aerial vehicle. As seen in FIG. 5, the 3D protected zone for the aerial vehicle includes 3D dimensionality related to altitude, latitude and/or longitude.

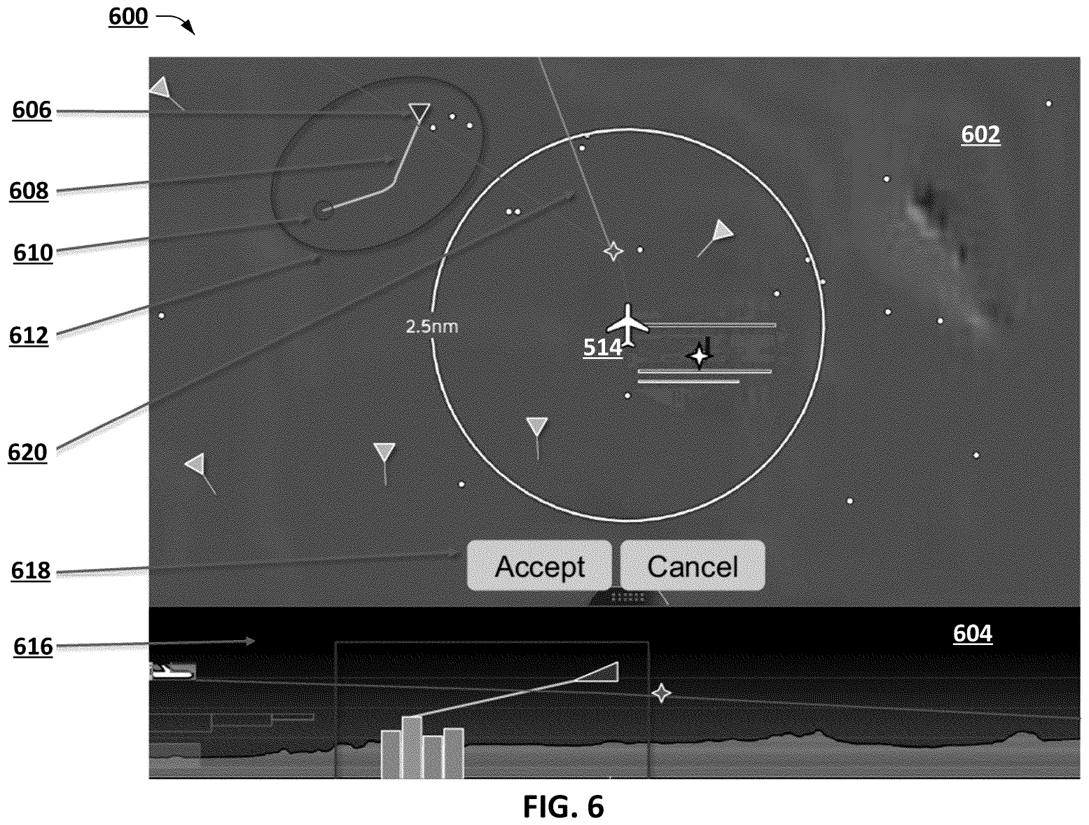

FIG. 6 illustrates an operational example of an electronic display configured to display one or more predicted energy overlays in accordance with at least some example embodiments of the present disclosure. Specifically, FIG. 6 illustrates a configuration of an electronic display 600. In various embodiments, the electronic display 600 may be an electronic display associated with one or more of a PFD, a VSD, an FMS, a vehicle apparatus 200, a remote operations center apparatus 316, and/or one or more other computing devices associated with the flight management platform 300. In various embodiments, the electronic display 600 can be rendered via one or more electronic displays associated with the different aerial vehicle 350 (e.g., the electronic displays 358).

As shown in FIG. 6, the electronic display 600 is configured to display a plurality of interface elements associated with a flight plan being executed by an aerial vehicle such as the aerial vehicle 112 or the different aerial vehicle 350. The electronic display 600 is divided into an electronic map 602 and a VSD 604. The electronic map 602 can be, for example, a primary flight display of the aerial vehicle that provides an overhead view for depicting waypoints, designated locations, flight path data, and/or 3D protected zone data. Additionally the VSD 604 can provide a horizontal distance scale view for depicting a profile or side view of terrain, flight path data, and/or 3D protected zone data.

As depicted in FIG. 6, the electronic map 602 includes an overlay 606 representing an aerial vehicle (e.g., the aerial vehicle 112) associated with the emergency operations event, an overlay 608 representing an emergency flight path for an aerial vehicle associated with the emergency operations event, an overlay 610 representing a designated location for an aerial vehicle associated with the emergency operations event, and/or an overlay 612 representing a 3D protected zone for an aerial vehicle associated with the emergency operations event. The electronic map 602 also includes an overlay 614 representing a real-time location of the aerial vehicle (e.g., the different aerial vehicle 352). Additionally, as depicted in FIG. 6, the VSD 604 includes an overlay 616 representing another rending of the 3D protected zone for the aerial vehicle. The VSD 604 additionally includes an interactive graphical element 618 configured to receive a user action to accept or cancel (e.g., deny) an alternate flight path related to the 3D protected zone. In certain embodiments, in response to acceptance of the alternate flight path via the interactive graphical element 618, the VSD 604 includes an overlay 620 representing the alternate flight path for the aerial vehicle (e.g., the different aerial vehicle 352) to avoid the 3D protected zone associated with the overlay 612 and the overlay 616. As seen in FIG. 6, the 3D protected zone for the aerial vehicle includes 3D dimensionality related to altitude, latitude and/or longitude.

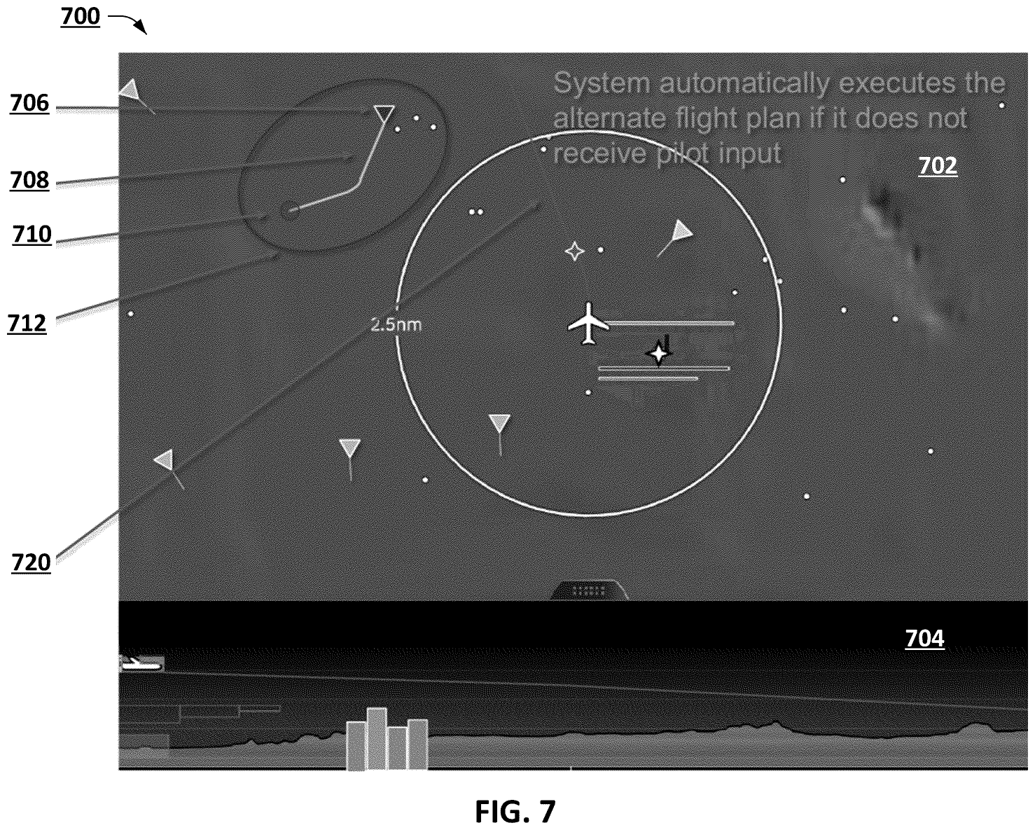

FIG. 7 illustrates an operational example of an electronic display configured to display one or more predicted energy overlays in accordance with at least some example embodiments of the present disclosure. Specifically, FIG. 7 illustrates a configuration of an electronic display 700. In various embodiments, the electronic display 700 may be an electronic display associated with one or more of a PFD, a VSD, an FMS, a vehicle apparatus 200, a remote operations center apparatus 316, and/or one or more other computing devices associated with the flight management platform 300. In various embodiments, the electronic display 700 can be rendered via one or more electronic displays associated with the different aerial vehicle 350 (e.g., the electronic displays 358).

As shown in FIG. 7, the electronic display 700 is configured to display a plurality of interface elements associated with a flight plan being executed by an aerial vehicle such as the aerial vehicle 112 or the different aerial vehicle 350. The electronic display 700 is divided into an electronic map 702 and a VSD 704. The electronic map 702 can be, for example, a primary flight display of the aerial vehicle that provides an overhead view for depicting waypoints, designated locations, flight path data, and/or 3D protected zone data. Additionally the VSD 704 can provide a horizontal distance scale view for depicting a profile or side view of terrain, flight path data, and/or 3D protected zone data.

As depicted in FIG. 7, the electronic map 702 includes an overlay 706 representing an aerial vehicle (e.g., the aerial vehicle 112) associated with the emergency operations event, an overlay 708 representing an emergency flight path for an aerial vehicle associated with the emergency operations event, an overlay 710 representing a designated location for an aerial vehicle associated with the emergency operations event, and/or an overlay 712 representing a 3D protected zone for an aerial vehicle associated with the emergency operations event. The electronic map 702 also includes an overlay 720 representing the alternate flight path for the aerial vehicle (e.g., the different aerial vehicle 352) to avoid the 3D protected zone associated with the overlay 712. In certain embodiments, the overlay 720 is generated in response to input not being received via the interactive graphical element 618. For example, the overlay 720 is generated in response a certain amount of time being realized since rendering of the interactive graphical element 618. In certain embodiments, the VSD 704 includes a rendering of the 3D protected zone.

### EXAMPLE PROCESSES OF THE DISCLOSURE

Having described example systems, apparatuses, data flows, user interfaces, and user interface elements in accordance with the present disclosure, example processes of the disclosure will now be discussed. It will be appreciated that each of the flowcharts depicts an example computer-implemented process that is performable by various means, including one or more of the apparatuses, systems, devices, and/or computer program products described herein, for example utilizing one or more of the specially configured components thereof.

It will be understood that each block of the processes, and combinations of blocks in the flowcharts, may be implemented by various means including hardware and/or a computer program product comprising one or more computer-readable mediums having computer-readable program instructions stored thereon. For example, one or more of the processes described herein in some embodiments is/are embodied by computer program of a computer program product. In this regard, the computer program product(s) that embody the process(es) described herein in some embodiments comprise one or more non-transitory memory devices of a computing device, apparatus, and/or the like (for example, the memory 204 of the vehicle apparatus 200) storing instructions executable by a processor of a computing device (for example, by the processor 202 of the vehicle apparatus 200). In some embodiments, the computer program instructions of the computer program product that embody the processes are stored by non-transitory computer-readable storage mediums of a plurality of computing devices. It will be appreciated that any such computer program product(s) may be loaded onto one or more computer(s) and/or other programmable apparatus(es) (for example, a vehicle apparatus 200), such that the computer program product including the program code instructions that execute on the computer(s) or other programmable apparatus(es) create means for implementing the functions specified in the operational block(s).

Further, in some embodiments, the computer program product includes one or more non-transitory computer-readable memories on which the computer program instructions are stored such that the one or more computer-readable memories can direct one or more computer(s) and/or other programmable apparatus(es) to function in a particular manner, such that the computer program product comprises an article of manufacture that implements the function(s) specified in the operational block(s). Additionally or alternatively, in some embodiments, the computer program instructions of one or more computer program product(s) are loaded onto computing device(s) or other programmable apparatus(es) to cause a series of operations to be performed on the computing device(s) or other programmable apparatus(es) a computer-implemented process such that the instructions that execute on the computing device(s) or other programmable apparatus(es) implement the functions specified in the operational block(s).

Each of the processes depicted includes a plurality of operational blocks defining a particular algorithm for performing one or more portion(s) of functionality for generating and/or outputting improved user interface(s) as described herein. The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

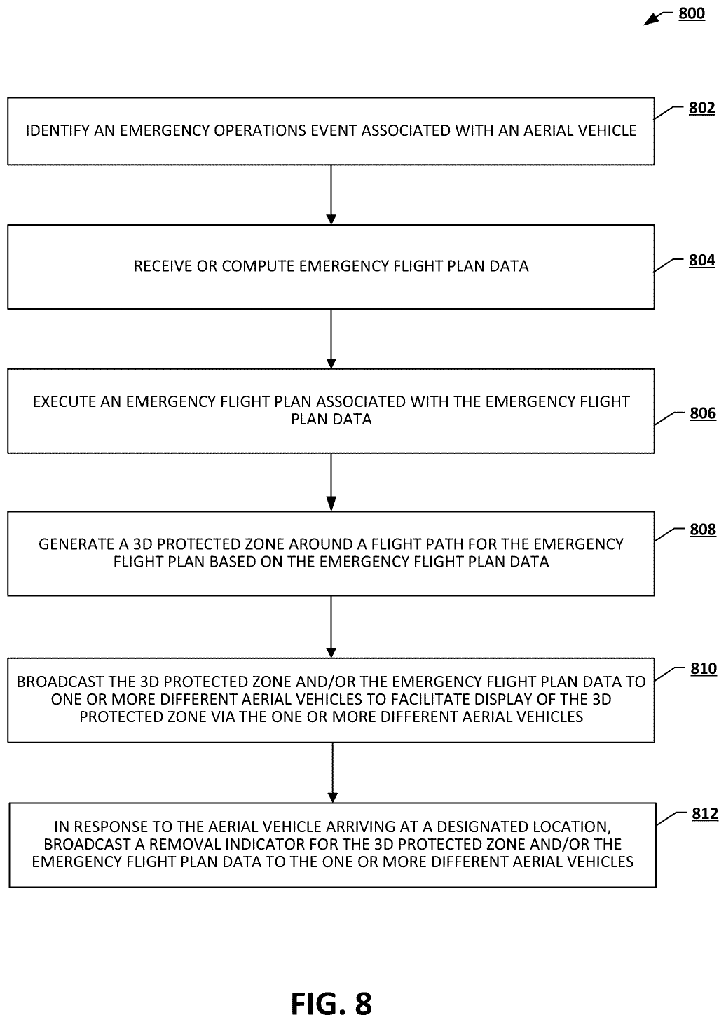

FIG. 8 illustrates a flowchart depicting example operations of an example process for providing autonomous protected flight zones during emergency operations of aerial vehicles associated with a flight management platform 300 in accordance with at least some example embodiments of the present disclosure. In certain embodiments, FIG. 8 depicts operations of an example process 800 for generating one or more 3D protected zone overlays for one or more vehicle(s) whose operation is being impacted by one or more adverse situations. In some embodiments, the process 800 is embodied by a computer-implemented process executable by any of a myriad of computing device(s), apparatus(es), system(s), and/or the like as described herein. Alternatively or additionally, in some embodiments, the process 800 is embodied by computer program code stored on a non-transitory computer-readable storage medium of a computer program product configured for execution to perform the process as depicted and described.

Alternatively or additionally, in some embodiments, the process 800 is performed by one or more specially configured computing devices, such as the vehicle apparatus 200 alone or in communication with one or more other component(s), device(s), system(s), and/or the like (e.g., such as the remote operations center apparatus 316). In this regard, in some such embodiments, the vehicle apparatus 200 is specially configured by computer-coded instructions (e.g., computer program instructions) stored thereon, for example in the memory 204 and/or another component depicted and/or described herein and/or otherwise accessible to the vehicle apparatus 200, for performing the operations as depicted and described. In some embodiments, the vehicle apparatus 200 is in communication with one or more external apparatus(es), system(s), device(s), and/or the like, to perform one or more of the operations as depicted and described. For example, the vehicle apparatus 200 in some embodiments is in communication with an end-user computing device, one or more external system(s), and/or the like (e.g., such as the remote operations center 314). It will be appreciated that while the process 800 is described as performed by and from the perspective of the vehicle apparatus 200 for purposes of simplifying the description, the process 800 can also be performed, in total or in part, by the remote operations center apparatus 316 of the remote operations center 314.

The process 800 begins at operation 802. At operation 802, the vehicle apparatus 200 includes means such as the processor 202, the memory 204, the input/output circuitry 206, the communications circuitry 208, the sensor(s) 210, the vehicle control circuitry 212, the 3D protected zone circuitry 214, and/or the like, or a combination thereof, that identifies an emergency operations event associated with an aerial vehicle (e.g., the aerial vehicle 112).

At operation 804, the vehicle apparatus 200 includes means such as the processor 202, the memory 204, the input/output circuitry 206, the communications circuitry 208, the sensor(s) 210, the vehicle control circuitry 212, the 3D protected zone circuitry 214, and/or the like, or a combination thereof, that receives or computes emergency flight plan data.

In one or more embodiments, the emergency flight plan data includes an emergency flight path of the aerial vehicle and/or an emergency destination location of the aerial vehicle.

At operation 806, the vehicle apparatus 200 includes means such as the processor 202, the memory 204, the input/output circuitry 206, the communications circuitry 208, the sensor(s) 210, the vehicle control circuitry 212, the 3D protected zone circuitry 214, and/or the like, or a combination thereof, that executes an emergency flight plan associated with the emergency flight plan data.

At operation 808, the vehicle apparatus 200 includes means such as the processor 202, the memory 204, the input/output circuitry 206, the communications circuitry 208, the sensor(s) 210, the vehicle control circuitry 212, the 3D protected zone circuitry 214, and/or the like, or a combination thereof, that generates a 3D protected zone around a flight path for the emergency flight plan based on the emergency flight plan data.

At operation 810, the vehicle apparatus 200 includes means such as the processor 202, the memory 204, the input/output circuitry 206, the communications circuitry 208, the sensor(s) 210, the vehicle control circuitry 212, the 3D protected zone circuitry 214, and/or the like, or a combination thereof, that broadcasts the 3D protected zone and/or the emergency flight plan data to one or more different aerial vehicles to facilitate display of the 3d protected zone via the one or more different aerial vehicles.

In one or more embodiments, broadcasting the 3D protected zone and/or the emergency flight plan data includes broadcasting the 3D protected zone and/or the emergency flight plan data via wireless communication.

In one or more embodiments, broadcasting the 3D protected zone and/or the emergency flight plan data includes broadcasting the 3D protected zone and/or the emergency flight plan data via satellite communication.

At operation 812, the vehicle apparatus 200 includes means such as the processor 202, the memory 204, the input/output circuitry 206, the communications circuitry 208, the sensor(s) 210, the vehicle control circuitry 212, the 3D protected zone circuitry 214, and/or the like, or a combination thereof, that, in response to the aerial vehicle arriving at a designated location, broadcast a removal indicator for the 3D protected zone and/or the emergency flight plan data to the one or more different aerial vehicles.

In one or more embodiments, the vehicle apparatus 200 includes means such as the processor 202, the memory 204, the input/output circuitry 206, the communications circuitry 208, the sensor(s) 210, the vehicle control circuitry 212, the 3D protected zone circuitry 214, and/or the like, or a combination thereof, that, causes rendering of a graphical element associated with the 3D protected zone via a display of the different aerial vehicle. In one or more embodiments, the display is a primary flight display of the different aerial vehicle. In one or more embodiments, the display is a vertical situation display of the different aerial vehicle.

In one or more embodiments, the vehicle apparatus 200 includes means such as the processor 202, the memory 204, the input/output circuitry 206, the communications circuitry 208, the sensor(s) 210, the vehicle control circuitry 212, the 3D protected zone circuitry 214, and/or the like, or a combination thereof, that, causes rendering of a graphical element associated with the 3D protected zone via a primary flight display and a vertical situation display of the different aerial vehicle.

In one or more embodiments, the vehicle apparatus 200 includes means such as the processor 202, the memory 204, the input/output circuitry 206, the communications circuitry 208, the sensor(s) 210, the vehicle control circuitry 212, the 3D protected zone circuitry 214, and/or the like, or a combination thereof, that, causes rendering of a graphical element associated with the 3D protected zone via a display of a remote operations platform.

In one or more embodiments, the vehicle apparatus 200 includes means such as the processor 202, the memory 204, the input/output circuitry 206, the communications circuitry 208, the sensor(s) 210, the vehicle control circuitry 212, the 3D protected zone circuitry 214, and/or the like, or a combination thereof, that, receives, from the different aerial vehicle, an acceptance indicator for the 3D protected zone in response to a user action with respect to an interactive graphical element rendered via a display of the different aerial vehicle.

### CONCLUSION

While several example contexts are described herein with respect to processing of data by an aerial vehicle, it will be appreciated in view of this disclosure that embodiments may include or otherwise be implemented as a part of other vehicle(s), device(s), and/or the like. For example, in other contexts, embodiments of the present disclosure utilize sensor(s) of and/or display data to display(s) of other type(s) of vehicle(s), including ground vehicle(s). Alternatively or additionally, some embodiments utilize sensor(s) of and/or display data to display(s) of other device(s), including user device(s), back-end computing device(s), and/or the like. Indeed, in some embodiments, the sensor(s), computing device(s), and/or display(s) are embodied and/or otherwise included in one or more computing device(s) not integrated as part of any vehicle (e.g., as a standalone computing device). In is intended that all such contexts, device type(s), and/or the like be included within the scope of this disclosure and covered within the scope of the claims appended herein.

Although an example processing system is described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A computer-implemented method comprising:
generating a three-dimensional (3D) protected zone around a flight path for an aerial vehicle associated with an emergency operations event based on emergency flight plan data for the aerial vehicle;
broadcasting the 3D protected zone and the emergency flight plan data to a different aerial vehicle in a certain vicinity of the aerial vehicle; and
in response to the aerial vehicle arriving at a designated location, broadcasting a removal indicator for the 3D protected zone and the emergency flight plan data to the different aerial vehicle.

2. The computer-implemented method of claim 1, wherein broadcasting the 3D protected zone and the emergency flight plan data comprises broadcasting the 3D protected zone and the emergency flight plan data via wireless communication.

3. The computer-implemented method of claim 1, wherein broadcasting the 3D protected zone and the emergency flight plan data comprises broadcasting the 3D protected zone and the emergency flight plan data via satellite communication.

4. The computer-implemented method of claim 1, wherein the emergency flight plan data comprises an emergency flight path of the aerial vehicle and an emergency destination location of the aerial vehicle.

5. The computer-implemented method of claim 1, further comprising:
causing rendering of a graphical element associated with the 3D protected zone via a display of the different aerial vehicle.

6. The computer-implemented method of claim 5, wherein the display is a primary flight display of the different aerial vehicle.

7. The computer-implemented method of claim 5, wherein the display is a vertical situation display of the different aerial vehicle.

8. The computer-implemented method of claim 1, further comprising:
causing rendering of a graphical element associated with the 3D protected zone via a primary flight display and a vertical situation display of the different aerial vehicle.

9. The computer-implemented method of claim 1, further comprising:
causing rendering of a graphical element associated with the 3D protected zone via a display of a remote operations platform.

10. The computer-implemented method of claim 1, further comprising:
receiving, from the different aerial vehicle, an acceptance indicator for the 3D protected zone in response to a user action with respect to an interactive graphical element rendered via a display of the different aerial vehicle.

11. A computer program product comprising at least one non-transitory computer-readable storage medium having computer program code stored thereon that, in execution with at least one processor, is configured to:
generate a three-dimensional (3D) protected zone around a flight path for an aerial vehicle associated with an emergency operations event based on emergency flight plan data for the aerial vehicle;
broadcast the 3D protected zone and the emergency flight plan data to a different aerial vehicle in a certain vicinity of the aerial vehicle; and
in response to the aerial vehicle arriving at a designated location, broadcast a removal indicator for the 3D protected zone and the emergency flight plan data to the different aerial vehicle.

12. The computer program product of claim 11, wherein the computer program code is further configured to:
broadcast the 3D protected zone and the emergency flight plan data via wireless communication.

13. The computer program product of claim 11, wherein the computer program code is further configured to:
broadcast the 3D protected zone and the emergency flight plan data via satellite communication.

14. The computer program product of claim 11, wherein the emergency flight plan data comprises an emergency flight path of the aerial vehicle and an emergency destination location of the aerial vehicle.

15. The computer program product of claim 11, wherein the computer program code is further configured to:
cause rendering of a graphical element associated with the 3D protected zone via a display of the different aerial vehicle.

16. The computer program product of claim 15, wherein the display is a primary flight display of the different aerial vehicle.

17. The computer program product of 15, wherein the display is a vertical situation display of the different aerial vehicle.

18. The computer program product of claim 11, wherein the computer program code is further configured to:
cause rendering of a graphical element associated with the 3D protected zone via a primary flight display and a vertical situation display of the different aerial vehicle.

19. The computer program product of claim 11, wherein the computer program code is further configured to:
cause rendering of a graphical element associated with the 3D protected zone via a display of a remote operations platform.

20. An apparatus comprising:
at least one processor; and
at least one non-transitory memory storing instructions that, when executed by the at least one processor, cause the apparatus to:
generate a three-dimensional (3D) protected zone around a flight path for an aerial vehicle associated with an emergency operations event based on emergency flight plan data for the aerial vehicle;
broadcast the 3D protected zone and the emergency flight plan data to a different aerial vehicle in a certain vicinity of the aerial vehicle; and
in response to the aerial vehicle arriving at a designated location, broadcast a removal indicator for the 3D protected zone and the emergency flight plan data to the different aerial vehicle.
